(19) United States
(12) Patent Application Publication
(10) Pub. No.: US 2025/0369134 A1
(43) Pub. Date: Dec. 4, 2025

(54) METHOD FOR ONE-STEP SYNTHESIS OF SINGLE ATOMS AND NANOPARTICLES CO-DECORATED CARBON NANOTUBE ARRAYS

(71) Applicant: City University of Hong Kong, Hong Kong (CN)

(72) Inventors: Johnny Chung Yin HO, Hong Kong (CN); Quan QUAN, Hong Kong (CN); Yuxuan ZHANG, Hong Kong (CN)

(21) Appl. No.: 18/677,285

(22) Filed: May 29, 2024

(51) Int. Cl. C25B 11/093; C25B 1/04; C25B 9/19; C25B 11/036

(52) U.S. Cl. CPC C25B 11/093; C25B 1/04; C25B 9/19; C25B 11/036

(57) ABSTRACT

A liquid-assisted chemical vapor deposition method for preparing hierarchical Ni/NiO@Ru—NC nanotube arrays includes forming Ni/NiO@Ru—NC on surfaces of the NF with single-atom Ru anchored on N-doped carbon (Ru—NC) nanotube and Janus Ni/NiO NPs encapsulated on the tips. The forming Ni/NiO@Ru—NC includes pretreating the NF; creating a CH₃CN/RuCl₃/Ar atmosphere in the tube furnace to in-situ grow the Ni/NiO@Ru—NC nanotube arrays on the pretreated NF. The bifunctional Ni/NiO@Ru—NC electrocatalyst exhibits overpotentials of 88 m V and 261 m V for hydrogen evolution reaction (HER) and oxygen evolution reaction (OER) at 100 mA cm⁻² in alkaline solution, respectively. Meanwhile, the bifunctional Ni/NiO@Ru—NC can stably operate an anion-exchange membrane water electrolysis (AEMWE) system for 50 hours under 500 mA cm⁻² at a voltage of 1.95±0.05 V in a 1.0 M KOH solution at room temperature. An overall water-splitting electrolyzer can be efficiently driven by a solar cell.

### BACKGROUND OF THE INVENTION

The electrochemical conversion of water into green hydrogen, serving as a clean and renewable fuel, has attracted significant attention as a solution to the environmental and energy challenges of the future.^{1,2} In principle, water electrolysis involves two half-reactions: the cathodic two-electron hydrogen evolution reaction (HER) and the anodic four-electron oxygen evolution reaction (OER).³⁻⁵ However, development of bifunctional electrocatalysts for both HER and OER at large current density while simultaneously maintaining good performance and stability presents a formidable challenge, critical for the practical realization of water-splitting technology.

Confinement of active species at controllable dimensions into diverse porous hosts (i.e., carbons, polymers, and zeolites) has been widely recognized in various catalytic applications for high performance and structural stability. Among them, carbon-confined nanomaterials are highly attractive because the carbon matrix, as a well-conductive support, can effectively stabilize the active species and optimize their local electronic structures.⁶⁻⁹ Especially, confining metallic nanoparticles (NPs) into nitrogen-doped carbon (NC) nanotubes has been demonstrated as a general method for electrocatalytic water splitting applications under the cladding effect of the robust yet flexible carbon sheath.¹⁰ However, limited active sites in the NC matrix and the poor stability of metal NPs under harsh conditions hinder their practical applications.

In this context, atomically dispersed metal sites confined into the NC matrix by coordination with nonmetal atoms have been investigated to improve the accessibility of active species.^{11,12}

In addition, the surface electronic structure modification of metal NPs via constructing a Janus heterostructure can potentially enrich the active sites and improve stability.¹³ Consequently, the co-introduction of single-atom metal sites in conjunction with Janus metal heterostructures into the NC matrix by the confinement engineering method at multiscale holds the potential to overcome existing bottlenecks, thereby achieving remarkable catalytic performance.

### BRIEF SUMMARY OF THE INVENTION

There continues to be a need in the art for improved designs and techniques for a method and systems for synthesizing single atoms and nanoparticles co-decorated carbon nanotube arrays.

According to an embodiment of the subject invention, a liquid-assisted chemical vapor deposition (LCVD) method for preparing hierarchical Ni/NiO@Ru—NC nanotube arrays is provided. The method comprises pretreating nickel foam (NF); forming Ni/NiO@Ru—NC on surfaces of the NF with single-atom Ru anchored on N-doped carbon (Ru—NC) nanotube and Janus Ni/NiO NPs encapsulated on the tip. The pretreating NF comprises immersing the NF into a predetermined concentration of H₂SO₄ solution for a predetermined period of time; cleansing the NF by sequential sonication treatments in acetone, ethanol, and deionized (DI) water; and drying the NF at a predetermined temperature, wherein the predetermined concentration is about 0.5 M, the predetermined period of time is about 15 min, the predetermined temperature is about 60° C. The forming Ni/NiO@Ru—NC comprises disposing the pretreated NF in a tube furnace; connecting a gas washing bottle containing a CH₃CN solution and RuCl₃·xH₂O to an inlet of the tube furnace; passing Argon (Ar) gas flow through the CH₃CN/RuCl₃·xH₂O mixed solution to create a CH₃CN/RuCl₃/Ar atmosphere in the tube; and calcinated the pretreated NF at a predetermined temperature for a predetermined period of time at a certain temperature ramping rate to form Ni/NiO@Ru—NC, wherein the predetermined temperature is about 700° C., the predetermined period of time is about 2 hours, and the temperature ramping rate is about 5° C. min⁻1. When the Ar gas flow is passed through the CH₃CN/RuCl₃.xH₂O mixed solution to create a CH₃CN/RuCl₃/Ar atmosphere in the tube furnace, the single-atom Ru anchored N-doped carbon (Ru—NC) nanotube arrays are formed with their apical domains encapsulating Janus Ni/NiO NPs by undertaking a carbothermal reduction process on the pretreated NF. During the carbothermal reduction process, the C₂H₃N is decomposed into species including hydrogen cyanide (HCN) and methane (CH₄), respectively, acting as nitrogenous and carbonaceous feedstocks to form Ru—NC. With a NiO layer formed on the surface of the pretreated NF, the Janus Ni/NiO NPs are first exsolved at the beginning of the process, and then the Ru—NC nanotubes start to grow with the Ni/NiO NPs at tips, their length and density increasing with the growth time. Further, each Janus Ni/NiO NP is encapsulated at a tip of the Ru—NC nanotube by the Ru—NC layers.

In certain embodiments of the subject invention, a bifunctional Ni/NiO@Ru—NC electrocatalyst for water-splitting comprises hierarchical Ni/NiO@Ru—NC nanotube arrays with single-atom Ru sites confined onto sidewalls and Janus Ni/NiO NPs confined at apical nanocavities of the nanotubes. Each Janus Ni/NiO NP is encapsulated at a tip of the Ru—NC nanotube arrays by Ru—NC layers while a clear heterointerface exists between two phases within the NP.

In some embodiments of the subject invention, an anion-exchange membrane water electrolysis (AEMWE) system for water splitting comprises the bifunctional Ni/NiO@Ru—NC electrocatalyst described above as an anode and a cathode; and an electrolyte solution. The bifunctional Ni/NiO@Ru—NC electrocatalysts are configured to achieve a steady voltage of 1.95±0.05 V in 1.0 M KOH at room temperature. An electrolyzer integrated with a solar cell for water splitting comprises the bifunctional Ni/NiO@Ru—NC electrocatalyst described above as an anode and a cathode; an electrolyte solution; and a silicon solar cell. The bifunctional Ni/NiO@Ru—NC electrocatalysts are configured to be efficiently driven to generate hydrogen by a solar cell under sunlight irradiation.

### BRIEF DESCRIPTION OF THE DRAWINGS

FIG. 1A is a schematic illustration of the preparation for Ni/NiO@Ru—NC, FIGS. 1B and 1C are SEM images, and FIG. 1D is a TEM image of Ni/NiO@Ru—NC, FIG. 1E show HRTEM and FFT images of the tip Ni/NiO NP encapsulated by Ru—NC layers, FIG. 1F is an aberration-corrected STEM image of Ru—NC (inset: HRTEM image of Ru—NC), and FIG. 1G show HAADF-STEM and the elemental mapping images of Ni/NiO@Ru—NC, according to an embodiment of the subject invention.

FIG. 2A shows XRD patterns, FIG. 2B shows Raman spectra of Ni/NiO@Ru—NC and Ni/NiO@NC, FIG. 2C shows Raman mapping of D-peak and G-peak intensity, and FIG. 2D shows an atomic ratio of elements in Ni/NiO@Ru—NC, FIG. 2E shows XANES, FIG. 2F shows FT-EXAFS spectra at the Ru K-edge of Ni/NiO@Ru—NC, Ru foil, and RuO₂, FIG. 2G shows FT-EXAFS fitting curve in R space of Ni/NiO@Ru—NC (inset: optimized Ru—N₅—C configuration by DFT calculations), FIG. 2H shows WT plots of the k³-weighted Ru K-edge EXAFS, and FIG. 2I shows the differential charge density of Ru—N₅—C at the sidewall part, Ni/NiO and Ni/NiO@Ru—N₅—C at the top part (yellow contour, electron accumulation; cyan contour, electron depletion), according to an embodiment of the subject invention.

FIG. 3A shows Polarization curves, FIGS. 3B and 3D show overpotentials comparison, and FIGS. 3C and 3E show Tafel plots of tested samples for HER and OER, respectively, FIG. 3F shows CP curves of Ni/NiO@Ru—NC, and FIG. 3G shows overpotential comparisons at −100/100 mA cm⁻² with the reported carbon-supported metal-based materials, according to an embodiment of the subject invention.

FIG. 4A shows polarization curves, FIG. 4B shows potential comparisons with the reported carbon-based materials for overall water splitting. CP curves of the bifunctional Ni/NiO@Ru—NC electrode, FIG. 4C shows in the traditional two-electrode configuration (inset: contact angle), and FIG. 4D shows in the AEMWE system at 500 mA cm⁻² (inset: a photograph of the AEMWE system), FIG. 4E shows TDOS and PDOS of NC and Ru—N₅—C, FIG. 4F shows TDOS and PDOS of Ni/NiO, and FIG. 4G shows TDOS and PDOS of Ni/NiO@Ru—N₅—C, FIG. 4H shows a schematic illustration of the functional mechanism for NC, Ni/NiO@NC, and Ni/NiO@Ru—NC, according to an embodiment of the subject invention.

FIG. 5 is a schematic illustration of the LCVD system, according to an embodiment of the subject invention.

FIGS. 6A-6B are SEM images and corresponding elemental mapping, wherein FIG. 6A shows the surface of nickel foam (NF) and FIG. 6B shows the cross-section of one of NF skeletons after pretreatment, according to an embodiment of the subject invention.

FIGS. 7A-7D are SEM images of obtained materials by time-dependent control experiments, wherein FIG. 7A is for 10 minutes, FIG. 7B is for 30 minutes, FIG. 7C is for 60 minutes, and FIG. 7D is for 120 minutes, according to an embodiment of the subject invention.

FIG. 8 is a schematic illustration of the growth mechanism of Ni/NiO@Ru—NC nanotube arrays, according to an embodiment of the subject invention.

FIG. 9 shows line scanning profiles of Ni/NiO@Ru—NC along the recorded direction marked by a white line, according to an embodiment of the subject invention.

FIG. 10A is a SEM image, FIG. 10B is a TEM image with the red arrows showing the positions of Janus Ni/NiO particles, and FIG. 10C show HRTEM images of Ni/NiO@NC counterpart, according to an embodiment of the subject invention.

FIG. 11 shows XPS survey spectra of Ni/NiO@Ru—NC and Ni/NiO@NC, according to an embodiment of the subject invention.

FIG. 12 shows high-resolution XPS for C 1s coupled with Ru 3d spectra of Ni/NiO@Ru—NC and C 1s spectra of Ni/NiO@NC, according to an embodiment of the subject invention.

FIG. 13 shows high-resolution XPS spectra for N 1s of Ni/NiO@Ru—NC and Ni/NiO@NC, according to an embodiment of the subject invention.

FIG. 14 shows high-resolution XPS spectra for Ni 2p of Ni/NiO@Ru—NC and Ni/NiO@NC, according to an embodiment of the subject invention.

FIG. 15 shows high-resolution XPS for O 1s spectra of Ni/NiO@Ru—NC and Ni/NiO@NC, according to an embodiment of the subject invention.

FIG. 16 shows the optimized Ru—N₅—C configuration (grey, blue, and red balls represent carbon, nitrogen, and ruthenium atoms, respectively), according to an embodiment of the subject invention.

FIG. 17 shows differential charge density of Ru—N₅—C, according to an embodiment of the subject invention.

FIG. 18A shows polarization curves of Ni/NiO@Ru—NC with different amounts of RuCl₃·xH₂O for HER in 1.0 M KOH solution, and FIG. 18B shows overpotentials comparison at −100 mA cm⁻², according to an embodiment of the subject invention.

FIG. 19 shows AC-STEM images of the Ru—NC nanotube part of Ni/NiO@Ru—NC-100Ru, according to an embodiment of the subject invention.

FIG. 20 shows Nyquist plots and corresponding fitting results of Ni/NiO@Ru—NC and Ni/NiO@NC recorded at −0.23 V vs. RHE (inset: equivalent circuit), according to an embodiment of the subject invention.

FIG. 21A shows CV curves of Ni/NiO@Ru—NC, FIG. 21B shows CV curves of Ni/NiO@NC from 0.10 to 0.20 vs. RHE collected at 20, 40, 60, 80, and 100 mV s⁻¹ in 1.0 M KOH solution, FIG. 21C shows the corresponding C_{dl} values of Ni/NiO@Ru—NC and FIG. 21D shows the corresponding C_{dl} values of Ni/NiO@NC, according to an embodiment of the subject invention.

FIG. 22 is a cross-sectional SEM image of Ni/NiO@Ru—NC after HER stability test, according to an embodiment of the subject invention.

FIG. 23 shows XRD pattern of Ni/NiO@Ru—NC after HER stability test, according to an embodiment of the subject invention.

FIG. 24A shows XPS survey spectrum, FIG. 24B shows high-resolution XPS spectra, for C 1s+Ru 3d+K 2p, FIG. 24C shows high-resolution XPS spectra for N 1s, FIG. 24D shows high-resolution XPS spectra for Ni 2p, and FIG. 24E shows high-resolution XPS spectra for O 1s of Ni/NiO@Ru—NC after HER stability test, according to an embodiment of the subject invention.

FIG. 25A shows polarization curves of Ni/NiO@Ru—NC with different amounts of RuCl₃·xH₂O for OER in 1.0 M KOH solution, and FIG. 25B shows overpotentials comparison at 100 mA cm⁻², according to an embodiment of the subject invention.

FIG. 26 shows Nyquist plots and corresponding fitting results of Ni/NiO@Ru—NC and Ni/NiO@NC recorded at 1.52 V vs. RHE (inset: equivalent circuit), according to an embodiment of the subject invention.

FIG. 27A shows CV curves of Ni/NiO@Ru—NC, FIG. 27B shows CV curves of Ni/NiO@NC from 1.00 to 1.10 vs. RHE collected at 20, 40, 60, 80, and 100 mV s⁻¹ in 1.0 M KOH solution, FIG. 27C shows the corresponding C_{dl} values of Ni/NiO@Ru—NC and FIG. 27D shows the corresponding C_{dl} values of Ni/NiO@NC, according to an embodiment of the subject invention.

FIG. 28 shows a SEM image of Ni/NiO@Ru—NC after OER stability test, according to an embodiment of the subject invention.

FIG. 29 shows a XRD pattern of Ni/NiO@Ru—NC after OER stability test, according to an embodiment of the subject invention.

FIG. 30A shows XPS survey spectrum and FIG. 30B shows high-resolution XPS spectra for C 1s+Ru 3d+K 2p, FIG. 30C shows high-resolution XPS spectra for N 1s, FIG. 30D shows high-resolution XPS spectra for Ni 2p, and FIG. 30E shows high-resolution XPS spectra for O 1s of Ni/NiO@Ru—NC after OER stability test, according to an embodiment of the subject invention.

FIG. 31 shows potential comparison at different current densities of Ni/NiO@Ru—NC∥ Ni/NiO@Ru—NC, Ni/NiO@NC∥Ni/NIO@NC, and RuO₂∥Pt/C for overall water splitting, according to an embodiment of the subject invention.

FIG. 32 shows the optimized NC configuration (grey and blue balls represent carbon and nitrogen atoms, respectively), according to an embodiment of the subject invention.

FIG. 33A shows a digital photograph of the Ni/NiO@Ru—NC∥Ni/NiO@Ru—NC electrolyzer driven by a silicon solar cell, and FIG. 33B shows a magnified photograph of the two-electrode setup and corresponding electrodes, according to an embodiment of the subject invention.

TABLE 1
EXAFS fitting parameters at the Ru K-edge for various samples.

| Sample | Shell | CN^{a} | R(Å)^{b} | σ²(Å²)^{c} | ΔE₀ (eV)^{d} | R factor |
|---|---|---|---|---|---|---|
| Ru foil | Ru—Ru | 12* | 2.668 ± 0.003 | 0.0030 ± 0.0004 | 4.2 ± 0.6 | 0.0061 |
| | Ru—O | 6.1 ± 0.4 | 1.969 ± 0.001 | 0.0020 ± 0.0007 | −0.8 ± 0.5 | |
| RuO₂ | Ru—Ru | 9.5 ± 1.5 | 3.146 ± 0.001 | 0.0093 ± 0.0013 | −3.3 ± 0.6 | 0.0052 |
| | Ru—Ru | 4.4 ± 0.3 | 3.589 ± 0.001 | 0.0004 ± 0.0001 | 5.8 ± 0.6 | |
| Ni/NiO@ | Ru—N | 4.8 ± 0.4 | 2.024 ± 0.001 | 0.0070 ± 0.0012 | −0.3 ± 0.4 | 0.0040 |
| Ru—NC | | | | | | |

^{a}CN, coordination number;
^{b}R, the distance to the neighboring atom;
^{c}σ², the Mean Square Relative Displacement (MSRD);
^{d}ΔE₀, inner potential correction;
R factor indicates the goodness of the fit. S₀² is fixed to 0.731, according to the experimental EXAFS fit of Ru foil by fixing CN as the known crystallographic value.
*This value is fixed during EXAFS fitting based on the known structure of Ru. Fitting range: 3.0 ≤ k (/Å) ≤ 12.0 and 1.0 ≤ R (Å) ≤ 2.9 (Ru foil); 3.0 ≤ k (/Å) ≤ 11.5 and 1.0 ≤ R (Å) ≤ 3.8 (RuO₂); 3.0 ≤ k (/Å) ≤ 12.0 and 1.0 ≤ R (Å) ≤ 2.1 (598-Ru); 3.0 ≤ k (/Å) ≤ 12.0 and 1.0 ≤ R (Å) ≤ 2.0 (Ni/NiO@Ru—NC). A reasonable range of EXAFS fitting parameters: 0.700 < S₀² < 1.000; CN > 0; σ² > 0 Å²; |ΔE0| < 15 eV; R factor < 0.02.

TABLE 2
The fitting results of EIS spectra shown in FIG.
20 using the equivalent circuit in its inset.

| | Rₛ | CPE₂ | R_{ct} | CPE₁ | R₁ |
|---|---|---|---|---|---|
| Sample | (Ω) | (F cm⁻²) | (Ω) | (F cm⁻²) | (Ω) |
| Ni/NiO@Ru—NC | 0.542 | 0.034 | 1.405 | 0.023 | 1.104 |
| Ni/NiO@NC | 0.556 | 0.026 | 5.846 | 0.043 | 1.104 |

The equivalent circuit is consisted of a resistor (Rₛ) in series with two parallel combination of a resistor (R₁ or R_{ct}) and a constant phase element (CPE₁ or CPE₂). Rₛ represents the uncompensated solution resistance. The time constant R₁-CPE₁ may relate to the interfacial resistance. R_{ct}-CPE₂ reflects the charge-transfer resistance.

TABLE 3
Comparison of the electrocatalytic performance of Ni/NiO@Ru—NC with
the previously reported carbon supported metal-based materials for HER in 1.0M KOH.

| | | η₁₀₀ | Tafel slope | | |
|---|---|---|---|---|---|
| Entry | Electrocatalyst | (mV) | (mV dec⁻¹) | Stability (h) | Reference |
| 1 | Ni/NiO@Ru—NC | 88 | 123 | 100 | This work |
| | | | | (−500 mA cm⁻²) | |
| 2 | Co@N—CS/N—HCP@CC | 201 | 65 | 30 | Adv. Energy Mater. |
| | | | | (−30 mA cm⁻²) | 2019, 9, 1803918 |
| 3 | Fe—Ni@NC—CNTs | 328 | 114 | 11 | Angew. Chem. 2018, |
| | | | | (−10 mA cm⁻²) | 130, 9059-9064 |
| 4 | DH—CuCo—P@NC/CC | 176 | 69 | 12 | Appl. Catal., B, 2023, |
| | | | | (−10 mA cm⁻²) | 2023, 325, 122295 |
| 5 | NiFe₂O₄/VACNT | 248 | 88 | 8 | Carbon, 2019, |
| | | | | (−10 mA cm⁻²) | 145, 201-208 |
| 6 | Ni—FeP/C | 177 | 72 | 12 | Sci. Adv. 2019, |
| | | | | (−10 mA cm⁻²) | 5, eaav6009 |
| 7 | WC—Co@CoSAsNCNTs/ | 192 | 80 | 30 | ACS Catal. 2021, |
| | CC | | | (−10 mA cm⁻²) | 11, 3958-3974 |
| 8 | Co@N—CNTs@rGO | 162 | 55 | 100 | Adv. Mater. 2018, |
| | | | | (−20 mA cm⁻²) | 30, e1802011 |
| | | | | 48 | |
| 9 | Ni@NCNT/NiMoN | 119 | 68 | (−10 mA cm⁻²; −100 | J. Mater. Chem. A, |
| | | | | mA cm⁻²) | 2019, 7, 13671-13678 |
| 10 | S—MoS₂@C | 293 | 99 | 24 | Adv. Energy Mater. |
| | | | | (−10 mA cm⁻²) | 2019, 9, 1802553 |

TABLE 4
The fitting results of EIS spectra shown in FIG.
26 using the equivalent circuit in its inset.

| | Rₛ | CPE₂ | R_{ct} | CPE₁ | R₁ |
|---|---|---|---|---|---|
| Sample | (Ω) | (F cm⁻²) | (Ω) | (F cm⁻²) | (Ω) |
| Ni/NiO@Ru—NC | 0.452 | 0.346 | 1.019 | 0.238 | 1.284 |
| Ni/NiO@NC | 0.633 | 0.142 | 8.806 | 0.29 | 1.525 |

The equivalent circuit is consisted of a resistor (Rₛ) in series with two parallel combination of a resistor (R₁ or R_{ct}) and a constant phase element (CPE₁ or CPE₂). Rₛ represents the uncompensated solution resistance. The time constant R₁-CPE₁ may relate to the interfacial resistance. R_{ct}-CPE₂ reflects the charge-transfer resistance.

TABLE 5
Comparison of the electrocatalytic performance of Ni/NiO@Ru—NC with
the previously reported carbon supported metal-based materials for OER in 1.0M KOH.

| | | η₁₀₀ | Tafel slope | | |
|---|---|---|---|---|---|
| Entry | Electrocatalyst | (mV) | (mV dec⁻¹) | Stability (h) | Reference |
| 1 | Ni/NiO@Ru—NC | 261 | 78 | 100 | This work |
| | | | | (500 mA cm⁻²) | |
| 2 | Co@N—CS/N—HCP@CC | 333 | 68 | 30 | Adv. Energy Mater. |
| | | | | (30 mA cm⁻²) | 2019, 9, 1803918 |
| 3 | Fe—Ni@NC—CNTs | 320 | 45 | 11 | Angew. Chem. 2018, |
| | | | | (10 mA cm⁻²) | 130, 9059-9064 |
| 4 | DH—CuCo—P@NC/CC | 339 | 84 | 12 | Appl. Catal., B, 2023, |
| | | | | (15 mA cm⁻²) | 2023, 325, 122295 |
| 5 | NiFe₂O₄/VACNT | 330 | 70 | 8 | Carbon, 2019, |
| | | | | (10 mA cm⁻²) | 145, 201-208 |
| 6 | Co/CNFs | 452 | 86 | 20 | Adv. Mater. 2019, |
| | | | | (10 mA cm⁻²) | 31, 1808043 |
| 7 | MoS₂/Ni₃S₂@CA | 445 | 47 | 20 | Small 2023, 19, |
| | | | | (10 mA cm⁻²) | 2205431 |
| 8 | Fe₃C—Co/NC | 473 | / | 17 | Adv. Funct. Mater. |
| | | | | (10 mA cm⁻²) | 2019, 29, 1901949 |
| 9 | Co—P SAC MWCNT | 360 | 64 | 10 | ACS Nano 2021, |
| | | | | (10 mA cm⁻²) | 15, 4416-4428 |
| 10 | Ni SAs@S/N—CMF | 342 | 51 | 60 | Adv. Mater. 2022, |
| | | | | (10 mA cm⁻²) | 34, 2203442 |

TABLE 6
Comparison of the electrocatalytic performance of Ni/NiO@Ru—NC with the previously
reported carbon supported metal-based materials for overall water splitting in 1.0M KOH.

| | | Potential | | |
|---|---|---|---|---|
| Entry | Electrocatalyst | at 100 mA cm⁻² (V) | Stability (h) | Reference |
| 1 | Ni/NiO@Ru—NC | 1.617 | 100 | This work |
| | | | (500 mA cm⁻²) | |
| 2 | Fe—Ni@NC—CNTs | 1.940 | 11 | Angew. Chem. 2018, |
| | | | (10 mA cm⁻²) | 130, 9059-9064 |
| 3 | DH—CuCo—P@NC/CC | 1.673 | 12 | Appl. Catal., B, 2023, |
| | | | (20 mA cm⁻²) | 2023, 325, 122295 |
| 4 | MoS₂/Ni₃S₂@CA | 1.64 | 24 | Small 2023, 19, |
| | | | (10 mA cm⁻²) | 2205431 |
| 5 | Co@Co—P@NPCNTs | 1.878 | 24 | Small 2020, 16, |
| | | | (20 mA cm⁻²) | 2002124 |
| 6 | Co@N—CNT/NF | 1.688 | 24 | Appl. Catal., B, 2020, |
| | | | (30 mA cm⁻²) | 271, 118939 |
| 7 | Ru/Cu—RuO₂/C | 1.67 | 11 | Small 2018, 14, |
| | | | (10 mA cm⁻²) | 1803009 |
| 8 | NC—NiCu—NiCuN | 1.92 | 50 | Adv. Funct. Mater. |
| | | | (10 mA cm⁻²) | 2018, 28, 1803278 |
| 9 | CNTs@Ir—CoNi₂S₄ | 2.375 | 24 | Materials Today Nano |
| | | | (10 mA cm⁻²) | 2023, 21, 100296 |
| 10 | m-NiTPyP/CNTs | 2.09 | 60 | Adv. Mater. 2023 |
| | | | (10 mA cm⁻²) | |

### DETAILED DISCLOSURE OF THE INVENTION

The embodiments of the subject invention pertain to a liquid-assisted chemical vapor deposition (LCVD) method for preparing hierarchical Ni/NiO@Ru—NC nanotube arrays.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention pertains. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

When the term “about” is used herein, in conjunction with a numerical value, it is understood that the value can be in a range of 90% of the value to 110% of the value, i.e. the value can be +/−10% of the stated value. For example, “about 1 kg” means from 0.90 kg to 1.1 kg.

In describing the invention, it will be understood that a number of techniques and steps are disclosed. Each of these has individual benefits and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

Enzyme-mimicking confined catalysis has attracted great interest in heterogeneous catalytic systems that can regulate the geometric or electronic structure of the active site and improve its performance. Herein, a liquid-assisted chemical vapor deposition (LCVD) method is provided to simultaneously confine the single-atom Ru sites onto sidewalls and Janus Ni/NiO nanoparticles (NPs) at the apical nanocavities to thoroughly energize the N-doped carbon nanotube arrays (denoted as Ni/NiO@Ru—NC). The bifunctional Ni/NiO@Ru—NC electrocatalyst exhibits overpotentials of 88 and 261 mV for hydrogen evolution reaction (HER) and oxygen evolution reaction (OER) at 100 mA cm⁻² in alkaline solution, respectively, all ranking the top tier among the carbon-supported metal-based electrocatalysts. Moreover, once integrated into an anion-exchange membrane water electrolysis (AEMWE) system, Ni/NiO@Ru—NC can act as an efficient and robust bifunctional electrocatalyst to operate stably for 50 h under 500 mA cm⁻². Theoretical calculations and experimental exploration demonstrate that the confinement of Ru single atoms and Janus Ni/NiO NPs can regulate the electron distribution with strong orbital couplings to activate the NC nanotube from sidewall to top, thus boosting overall water splitting.

SEM images and corresponding elemental mapping indicate the existence of the NiO layer on the pretreated nickel foam (NF). In particular, as revealed by elemental mapping of the cross-section as shown in FIG. 6B, the O element mainly occupies the periphery of the pretreated NF skeleton, further demonstrating a NiO layer on the surface of pretreated NF. The preformed NiO layer is an essential factor for the generation of Janus Ni/NiO NPs, which could be partially reduced into Ni as the exsolved Ni/NiO Janus NPs at the first stage of the Ni/NiO@Ru—NC growth.

During the first 10 minutes, the surface of pretreated NF becomes rough with the exsolved Ni/NiO NPs as shown in FIG. 7A. Then, the Ru—NC nanotubes grow with the Ni/NiO NPs at the tips, as shown in FIG. 7B. With reaction time increasing, the length and density of Ru—NC nanotubes increase, as shown in FIG. 7C. Finally, after 2 hours, the Ni/NiO@Ru—NC nanotube arrays are formed without exposing the surface of the NF substrate, as shown in FIG. 7D.

The Ru loading is tuned by adding the different amounts of RuCl₃·xH₂O (i.e., 0.1 mg, 1 mg, 10 mg, and 100 mg) into the 100 mL of CH₃CN solution as the precursor for the LCVD process. To clarify, the as-resultant Ni/NiO@Ru—NC is denoted as 0.1Ru, 1Ru, 10Ru, and 100Ru, accordingly.

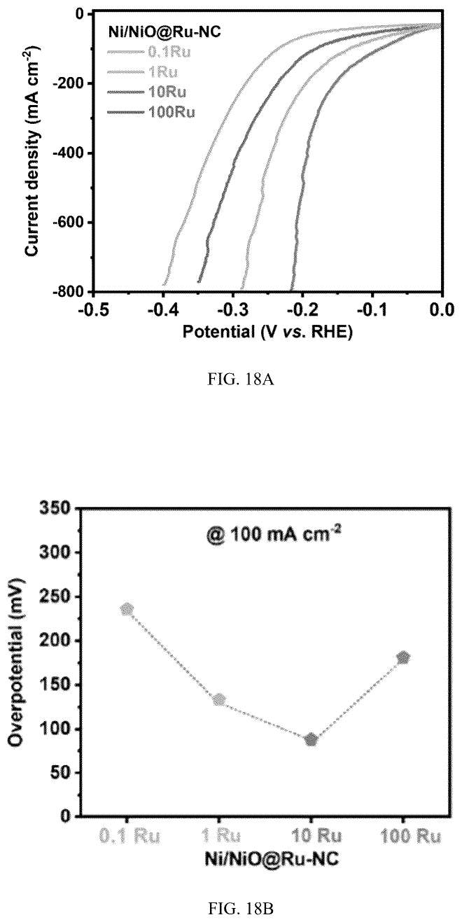

As illustrated in FIG. 18B, it is found that with an increase in Ru loading, the HER performance of Ni/NiO@Ru—NC is firstly increased and then decreased. The Ni/NiO@Ru—NC-10Ru exhibits the best HER activity. Therefore, adding 10 mg of RuCl₃·xH₂O is confirmed to be the best condition to obtain the optimal Ni/NiO@Ru—NC sample, which is characterized and studied in detail in this work.

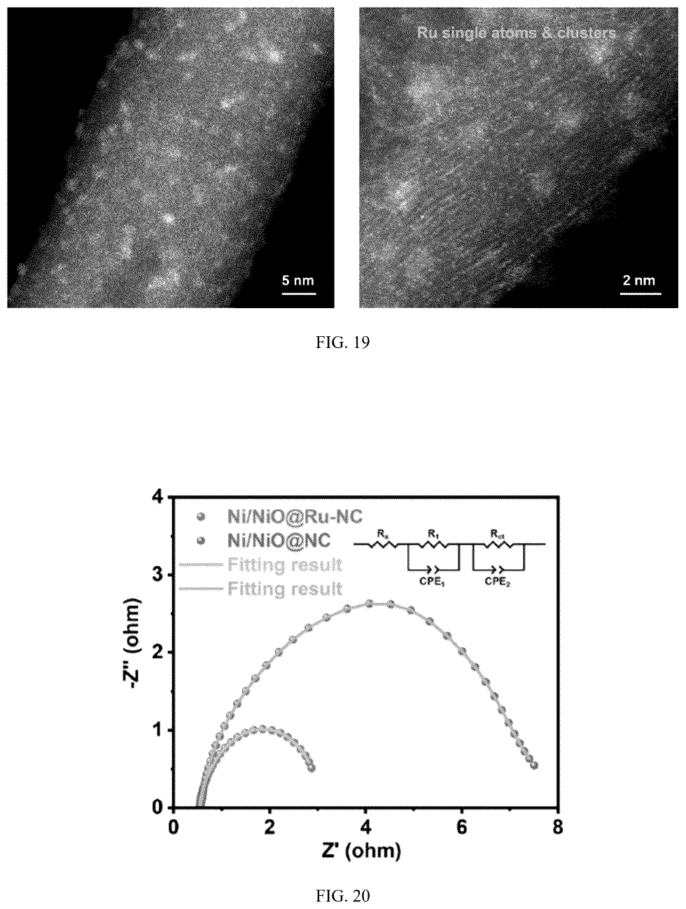

To explore the underlying reason for the decrease of HER activity of Ni/NiO@Ru—NC-100Ru as compared with Ni/NiO@Ru—NC-10Ru, the AC-STEM is conducted on the Ni/NiO@Ru—NC-100Ru sample as shown in FIG. 19. It is found that a mass of Ru clusters is homogeneously dispersed on the NC nanotube along with the existence of Ru single atoms, demonstrating that Ru tends to aggregate with further increasing the Ru loading. Because the Ni/NiO@Ru—NC-10Ru features Ru single atoms on the carbon nanotubes, it can be assumed that with the loading of single Ru atoms increasing (from 0.1Ru to 10 Ru), the HER activity is promoted. Then, as the Ru is aggregated into clusters (100Ru), the HER activity is decreased. Therefore, these results indicate that the single Ru atom is important for the enhanced HER activity.

Similarly, with an increase of Ru loading, the OER performance of Ni/NiO@Ru—NC is firstly increased and then decreased, further demonstrating that the loading amount and the configuration of Ru atom are vital for the enhanced OER activity.

### MATERIALS AND METHODS

### EXPERIMENTAL SECTION

Chemicals and Materials. Acetonitrile (CH₃CN) is purchased from RCI Labscan Ltd. Ruthenium trichloride hydrate (RuCl₃·xH₂O) is purchased from Sigma-Aldrich Co., Ltd. Potassium hydroxide (KOH) is purchased from Meryer Chemical Technology CO., Ltd. Nickel foam (NF) and anion exchange membrane (AEM, Dioxide Materials Sustainion X37-50RT) are purchased from Fuel Cell Store Co. Deionized (DI) water is obtained from local sources.

The Pretreatment of NF. The NF (thickness: 2 mm) is cut into rectangular pieces with a size of 2×3 cm². The NF pieces are immersed into 0.5 M H₂SO₄ solution for 15 min. Then, they are cleaned by sequential sonication treatment in acetone, ethanol, and DI water for 15 min each. Finally, the NF pieces are dried at 60° C. in the oven.

Synthesis of Ni/NiO@Ru—NC. One pretreated NF piece is put in the quartz tube center. A gas washing bottle containing 100 mL of CH₃CN solution and 10 mg of RuCl₃·xH₂O is connected to the air inlet of the tube furnace. Argon (Ar) flow is employed at 100 sccm to pass through the solution to create a CH₃CN/RuCl₃/Ar atmosphere. Next, the NF is calcinated at 700° C. for 2 h (ramping rate: 5° C. min⁻¹) to form the final product Ni/NiO@Ru—NC.

Synthesis of Ni/NiO@NC. Except for being without the addition of RuCl₃·xH₂O, the synthesis procedure of Ni/NiO@NC is the same as that of Ni/NiO@Ru—NC.

Characterizations. SEM is performed by using the FEI Quanta 450 equipment. TEM, HRTEM, HAADF-STEM, element mapping analysis, and line scans are carried out using a JEM-2100F instrument. The AC-STEM is conducted by applying a Thermo Fisher Scientific Spectra 300 S/TEM at an accelerating voltage of 300 kV. XPS is carried out on Thermo Fisher ESCALAB 250Xi equipment. Raman measurement is carried out on a WITec alpha300 R Raman System with a laser wavelength of 532 nm. Raman mapping is performed across a surface area of 1.0×1.0 μm². XRD patterns are collected on a Rigaku SmartLab high-resolution Xray diffractometer. The contact angle is tested by a Data Physics Contact Angle Tester. ICP-MS is conducted on a PE optima 6000 spectrometer. The characterization of the X-ray absorption fine structure (XAFS) is conducted at the Shanghai Synchrotron Radiation Facility (SSRF). The Ru K-edge XAFS analyses are performed with Si(311) crystal monochromators at the BL14W Beamline. The samples are placed into aluminum sample holders and sealed with a Kapton tape film before the analysis at the beamline. The XAFS spectra are collected at room temperature using a four-channel silicon drift detector (SDD) Bruker 5040. Ru K-edge EXAFS spectra are recorded in the fluorescence mode.

Meanwhile, the XAFS spectra of the reference samples are recorded in transmission mode. The Athena program is used for the process and analysis of the raw spectra obtained.

Electrochemical Tests. A standard three-electrode setup on an electrochemical workstation (CHI 760E) is applied to conduct all electrochemical measurements. Besides, the AEMWE system is controlled by an electrochemical workstation (CHI 660E) with a high-current amplifier (CHI 680C). KOH (1.0 M) is used as an electrolyte (pH=13.68). The catalyst/NF samples are directly employed as a working electrode with 0.5 cm² (that is, 0.5 cm×1 cm) for the reactions. The counter electrode is a graphite rod. The reference electrode is an Ag/AgCl electrode.

The electrolyte is bubbled with an Ar flow for 30 min before the electrochemical measurement. Numerous CV cycles are applied to activate the electrocatalysts until they remained stable. The linear sweep voltammetry (LSV) curves are collected with a scan rate of 5 mV s⁻¹. Unless otherwise mentioned, all polarization curves are exhibited with iR correction based on the formula E_{iR}=E₀−i×Rₛ. Rₛ represents solution resistance obtained from electrochemical impedance spectroscopy (EIS). EIS measurement is carried out with a frequency range from 100,000 to 0.01 Hz and an amplitude of 5 mV at −0.23 V vs. RHE for HER and at 1.52 V vs. RHE for OER. CV curves are collected at different scan rates in the potential range from 0.10 to 0.20 vs. RHE to evaluate the C_{dl} values for HER and from 1.00 to 1.10 vs. RHE for OER. The CP test is applied at −500/500 mA cm⁻² for HER/OER without iR compensation to evaluate the long-term stability. A two-electrode configuration is employed for the overall water-splitting test, and the corresponding long-term stability test is assessed by CP test at 500 mA cm⁻² without iR compensation in 1.0MKOH solution. In addition, 1 mL of electrolyte is periodically added into the long-term-tested system every 24 h. The Nernst equation is used to normalize all potentials to the RHE reference scale: E (vs. RHE)=E (vs. Ag/AgCl)+0.197 V+0.0591 V×pH.

Theoretical Computation. The first principle calculation based on DFT is realized by Vienna Ab-initio Simulation Package (VASP) code^{39,40} with the full-potential projected augmented wave (PAW) formalism.⁴¹ The generalized gradient approximation (GGA) under the Perdew-Burke-Ernzerhof (PBE) formalism is applied to describe exchange correlation.⁴² Grimme's DFT-D2 functional is used to evaluate the dispersive van der Waals interactions between composites. A vacuum layer of 20 Å is applied to avoid perturbations from neighboring layers. The cutoff energy for the plane-wave expansion is set to 450 eV. A convergence criterion of 10⁻⁵ eV is set for self-consistence, and the structure is relaxed until the maximum stress on each atom is lower than 0.01 eV/Å. The I-centered k-point mesh of 4×4×1 is used for the DOS calculation.

Following are examples that illustrate procedures for practicing the invention. These examples should not be construed as limiting. All percentages are by weight and all solvent mixture proportions are by volume unless otherwise noted.

### EXAMPLE 1—Design and Characterization of Ni/NiO@Ru—NC

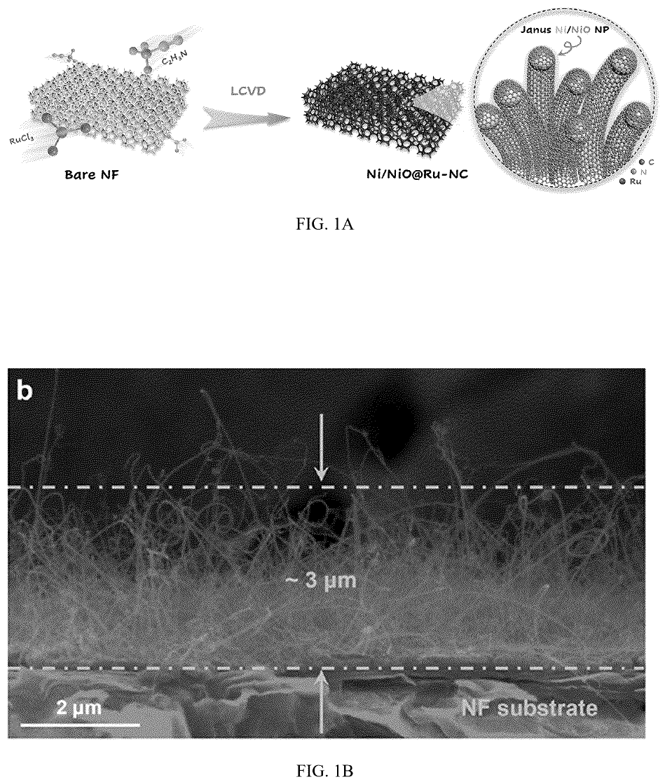

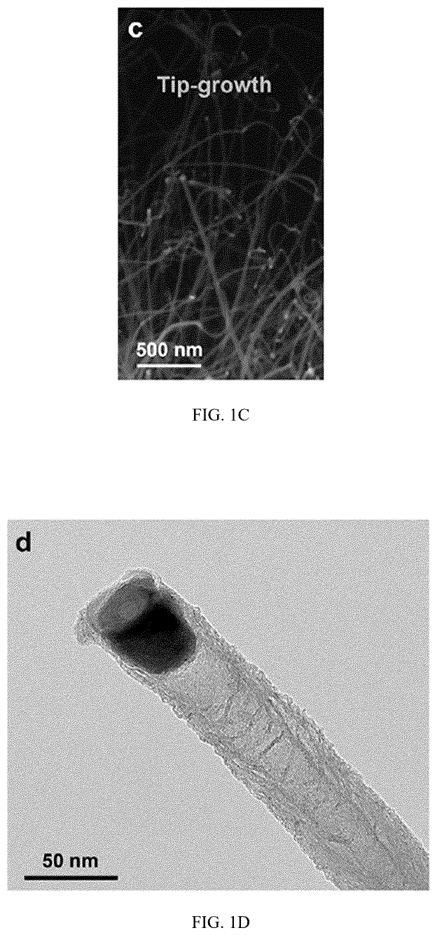

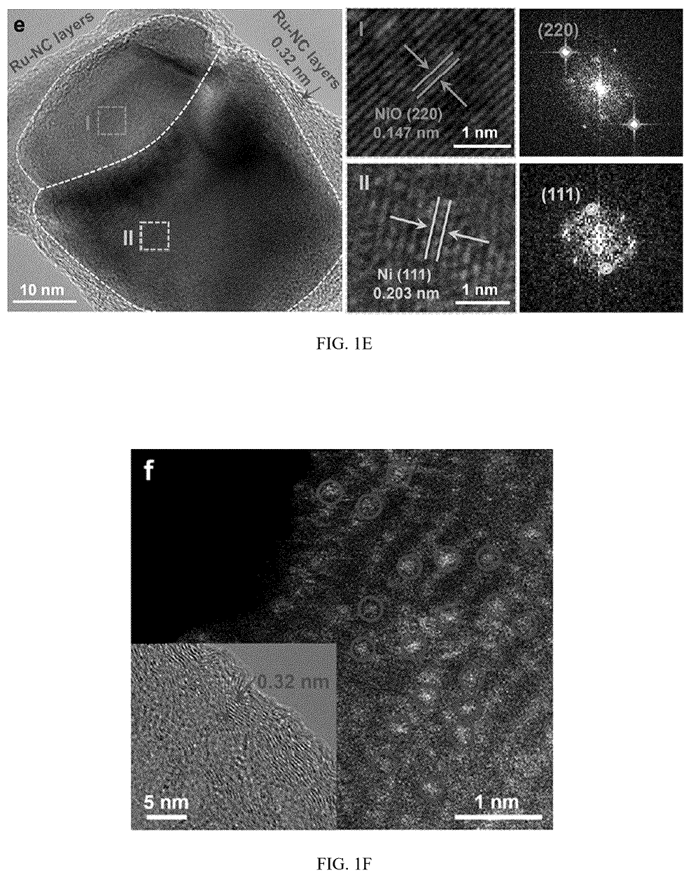

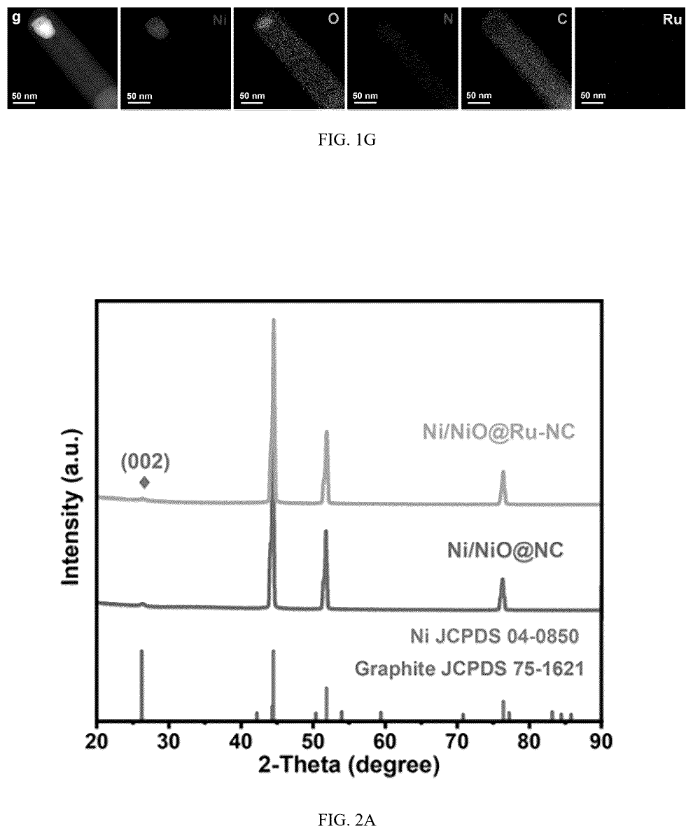

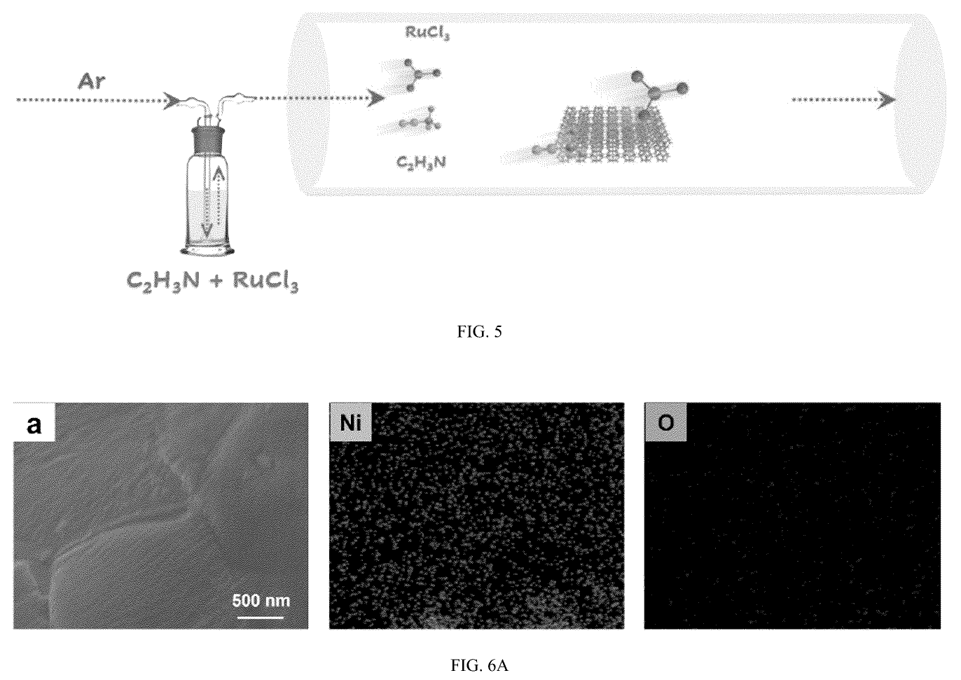

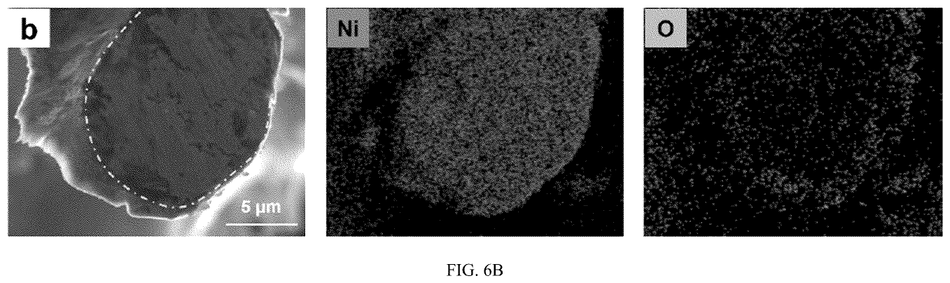

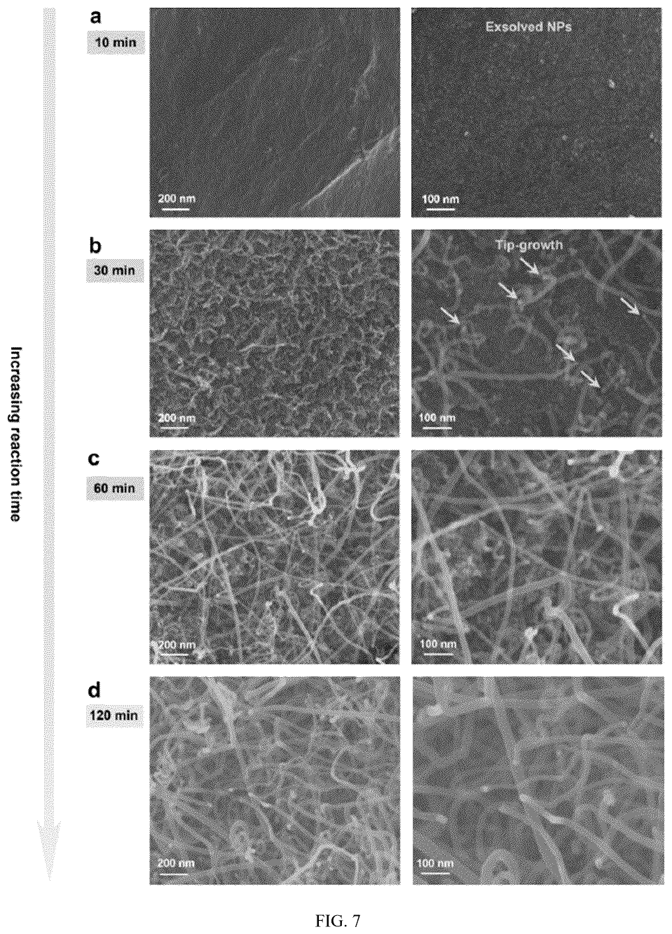

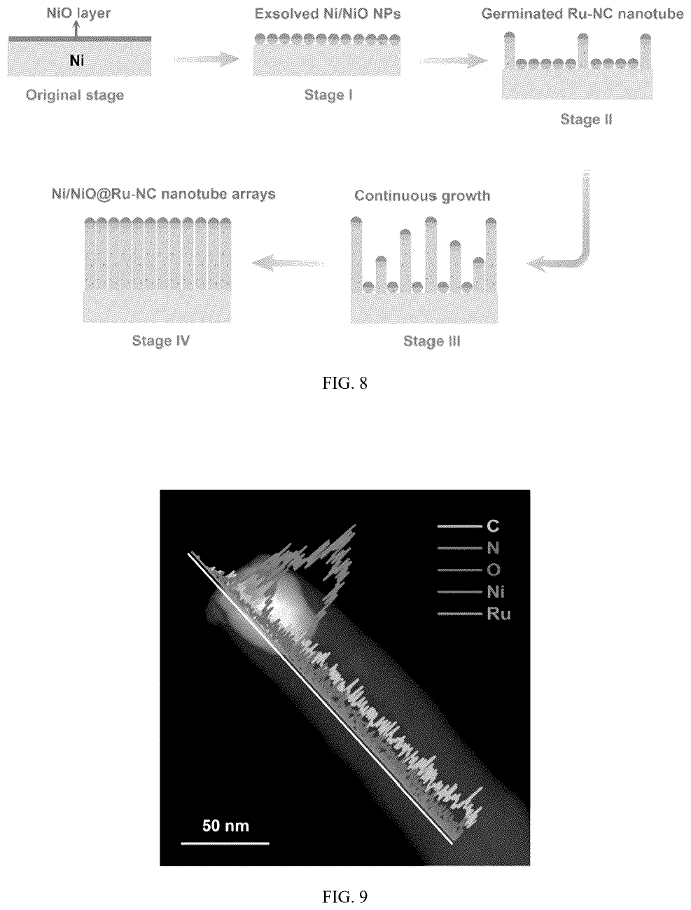

The hierarchical Ni/NiO@Ru—NC nanotube arrays are prepared using a one-step LCVD method, as schematically illustrated in FIG. 1A. Specifically, with the acetonitrile (C₂H₃N) and ruthenium trichloride (RuCl₃) bubbled into the high-temperature chamber, a carbothermal reduction process takes place on the pretreated nickel foam (NF) substrate to grow the single-atom Ru anchored N-doped carbon (Ru—NC) nanotube arrays with their apical domains encapsulating Janus Ni/NiO NPs as shown in FIG. 5. During this process, C₂H₃N is decomposed into different species, including hydrogen cyanide (HCN) and methane (CH₄), acting as the nitrogenous and carbonaceous feedstocks to form Ru—NC.¹⁴ With a NiO layer on the surface of pretreated NF as shown in FIGS. 6A and 6B, the Janus Ni/NiO NPs are first exsolved at the beginning. Then, the Ru—NC nanotubes start to grow with the Ni/NiO NPs at the tips, and their length and density increase with the growth time, as revealed by time-dependent control experiments as shown in FIG. 7. These observations demonstrate that the Ni/NiO NPs originated from the surface-oxidized NF can catalyze the growth of high-quality Ru—NC nanotubes in an acetonitrile atmosphere by the “tip-growth” mechanism,¹⁵ which is illustrated in FIG. 8. The cross-section field-emission scanning electron microscopy (FESEM) images of Ni/NiO@Ru—NC exhibit an array-structure integrated by the aligned, flexible carbon nanotubes on the NF skeleton with a length of ca. 3 μm as shown in FIGS. 1B and 1C.

Moreover, as depicted in FIG. 1D, the transmission electron microscopy (TEM) image of a single nanotube reveals that a Janus Ni/NiO NP is encapsulated at the tip of the Ru—NC nanotube. It can be observed from FIG. 1E that, at the tip part, the NP is wrapped by the Ru—NC layers with a lattice fringe of 0.34 nm while a clear heterointerface exists between the two phases within the NP. For the marked I and II regions of the NP part in FIG. 1E, the interplanar spacings of 0.147 and 0.203 nm displayed by high-resolution TEM (HRTEM) image and corresponding fast Fourier transform (FFT) patterns are consistent with the (220) lattice plane of NiO and the (111) lattice plane of metallic Ni, respectively, confirming the coexistence of NiO and Ni phases in the Janus-type NP.¹⁶ Meanwhile, in the HRTEM image for the carbon nanotube region (inset, FIG. 1F), parallel graphene lattices can be observed with an interplanar spacing of about 0.34 nm, and no obvious Ru clusters or nanoparticles are discerned. Subsequently, scanning TEM (STEM) and the corresponding elemental mapping are applied to evaluate the spatial element distribution in the Ni/NiO@Ru—NC as shown in FIG. 1G. It is observed that the Ni element intensively occupies the apical NP region, while the O element concentrates on the top half part of the NP. At the same time, the associated line scans further corroborate the Janus Ni/NiO structure within the tip NP as shown in FIG. 9. Moreover, the N and C elements are evenly distributed across the nanotube without the aggregation of the Ru element, indicating the formation of Ru—NC without Ru nanoparticles or clusters formed. In this regard, aberration-corrected scanning transmission electron microscopy (AC-STEM) is carried out to further explore the Ru species' configurations. As presented in FIG. 1F, the brighter spots can be attributed to the isolated Ru sites anchored in the carbon lattice, which are annotated with red circles.¹⁷ The formation of the atomically dispersed Ru can be ascribed to the fact that, during the LCVD-synthesized process, the abundant uncoordinated —CN groups act as Lewis bases to bind Ru complex ions; thus, the Ru site is stabilized and confined in the N-doped carbon matrix as Ru—Nₓ sites without further Ru assembling.³

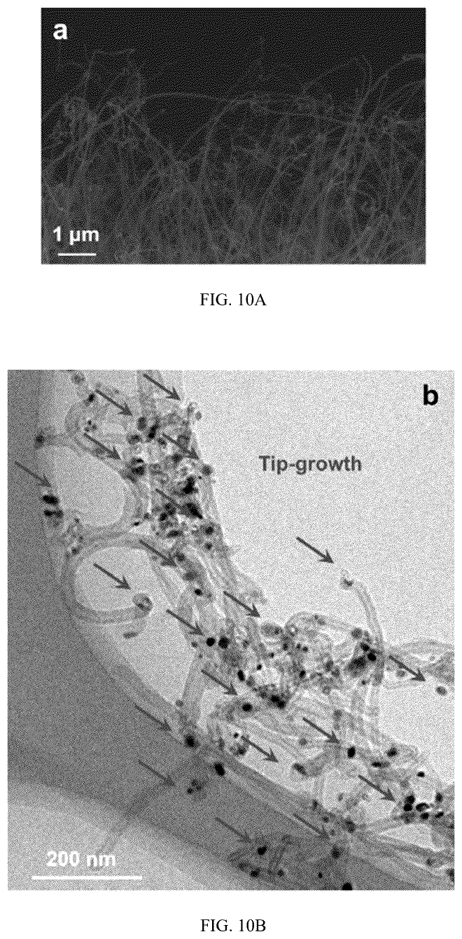

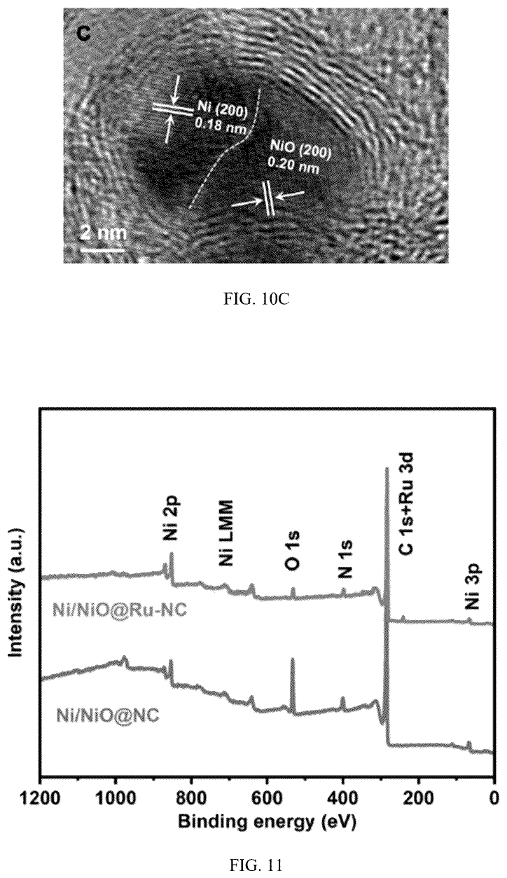

As a control experiment, the pure C₂H₃N solution without adding RuCl₃ is applied to synthesize the Ni/NiO@NC counterpart under identical conditions. It can be observed from SEM and HRTEM images that there are NC nanotube arrays grown on the NF substrate with the Janus Ni/NiO NPs encapsulated by NC layers on the tip, also following the “tip-growth” mechanism (FIGS. 10A-10C). Therefore, the successful synthesis of Ni/NiO@Ru—NC and Ni/NiO@NC demonstrates the generality and feasibility of the LCVD method to synthesize high-quality carbon nanotubes with Janus NPs and desirable single atoms in one step, which is distinguished from the traditional H₂/Ar calcination. Generally, the conventional calcination methods utilize the presynthesized carbonaceous precursors or the CH₄/C₂H₄ gas as carbon sources,^{18,19} which require multiple steps to obtain the functional carbon nanotubes.

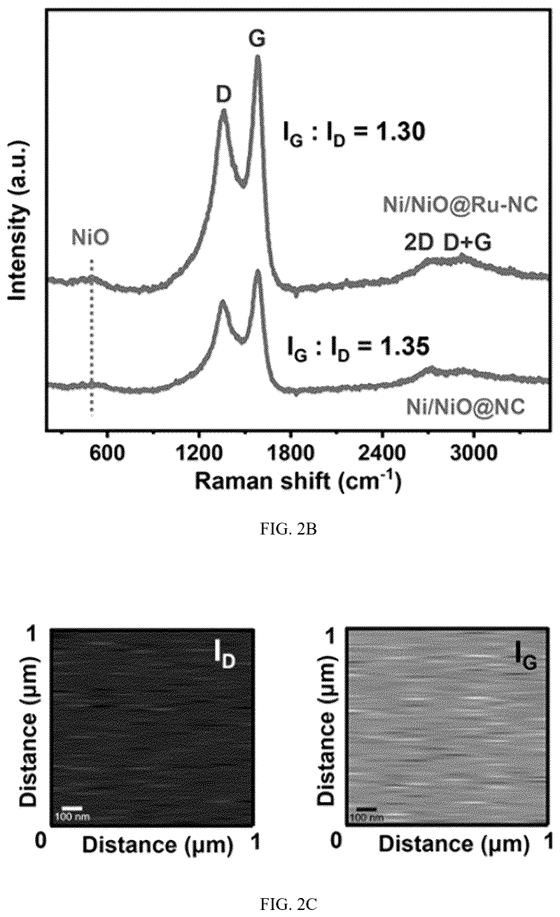

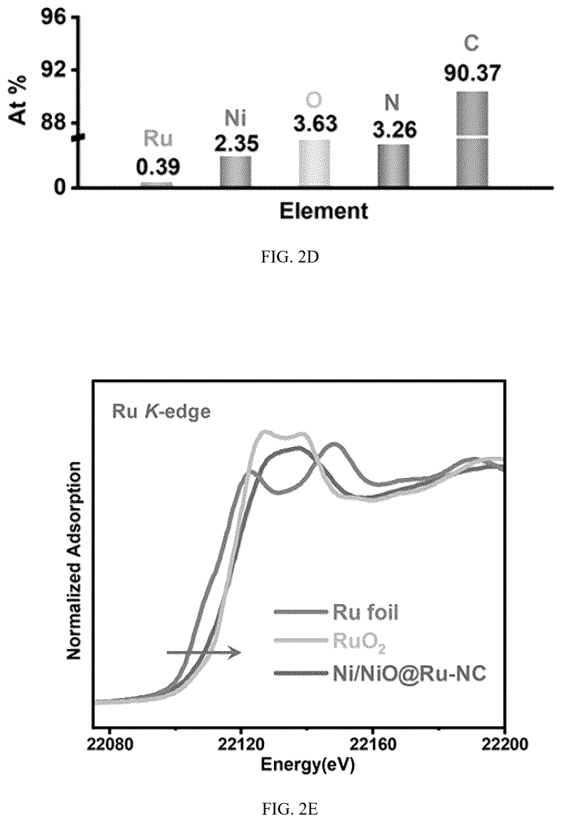

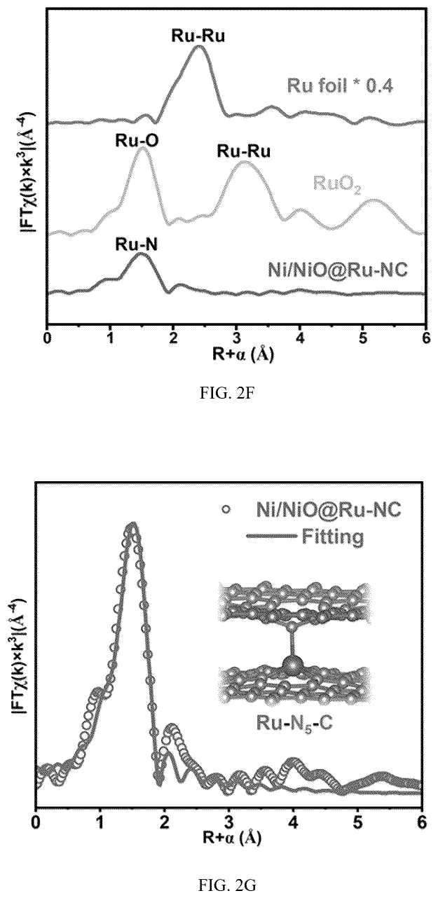

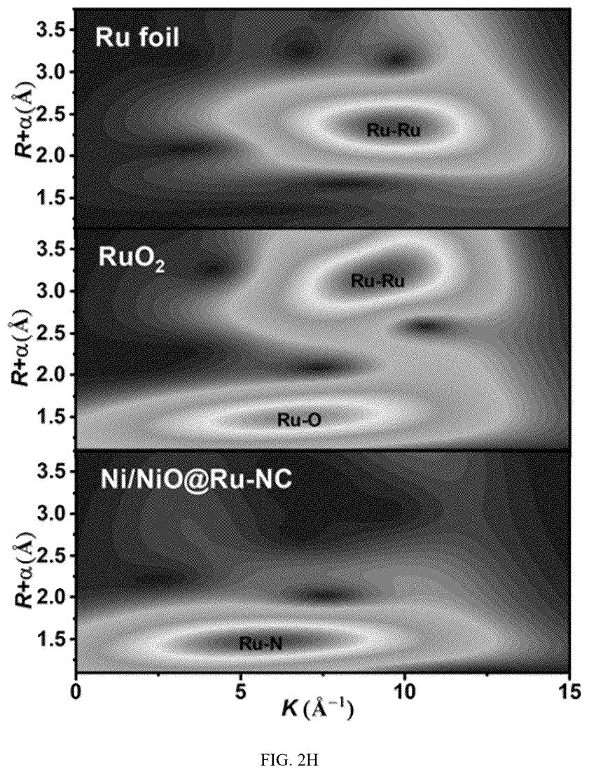

Further, the X-ray diffraction (XRD) patterns of Ni/NiO@Ru—NC and Ni/NiO@NC display strong diffraction peaks from Ni and NF substrate (JCPDS no. 04-0850) as shown in FIG. 2A. The characteristic peaks belonging to the (002) plane of graphitic carbon are detected at approximately 26.3° (JCPDS no. 75-1621). Additionally, the graphene-like NC in the two samples can be further validated by the presence of a prominent Gband (about 1580 cm⁻¹) and D band (about 1360 cm⁻¹) in the corresponding Raman spectra as shown in FIG. 2B, which are ascribed to the E_{2g} mode of sp²-hybridized carbon.²⁰ Meanwhile, in the second-order region, the band at around 2700 cm⁻¹ can be ascribed to the 2D band as the D-peak overtone, and another one at around 2930 cm⁻¹ can be attributed to the combined overtone of the D and G bands (denoted as D+G),²¹ also confirming the existence of graphene-like NC. Furthermore, the ratios of I_{G}/I_{D} for Ni/NiO@Ru—NC and Ni/NiO@NC are 1.30 and 1.35, respectively, suggesting the good crystallinity of graphite carbon synthesized by the LCVD method. Notably, the I_{G}/I_{D} of Ni/NiO@Ru—NC is relatively lower than that of Ni/NiO@NC, implying that Ru is atomically anchored in the NC matrix, inducing defects to a certain extent without destroying the main carbon lattice. More importantly, the Raman signals corresponding to the longitudinal optical (LO) mode of NiO are detected in both samples,¹⁶ indicating the existence of NiO. Furthermore, the Raman mapping of the integrated intensity for the D peak and G peak of Ni/NiO@Ru—NC highlights the full coverage of the Ru—NC on the surface of the NF substrate as shown in FIG. 2C.²²

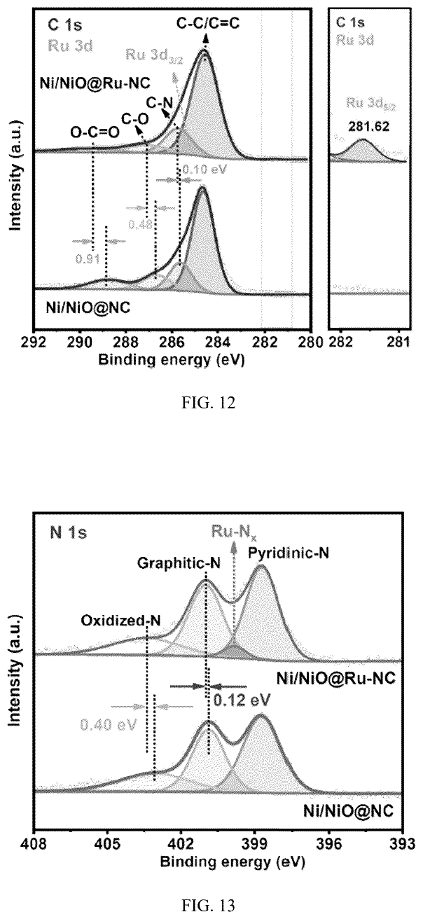

To elucidate the chemical composition and valence state, Ni/NiO@Ru—NC is studied by X-ray photoelectron spectroscopy (XPS), together with the Ni/NiO@NC counterpart. In the Ni/NiO@Ru—NC, a trace amount of Ru is detected apart from the coexistence of Ni/NiO and NC as shown in FIG. 2D and FIG. 11.²³ Additionally, the loading of Ru is further measured to be 2.53 wt % by inductively coupled plasma-mass spectroscopy (ICP-MS) analysis. In detail, the deconvolution of the C 1s profile of Ni/NiO@NC displays four peaks at 284.6, 285.92, 288.59, and 291.30 eV, ascribed to the C—C/C═C, C—N, C—O, and O—C═O groups of the NC, respectively as shown in FIG. 12. Furthermore, two new peaks for Ru 3d_{5/2} and Ru 3d_{3/2} emerge at 281.62 and 285.31 eV, suggesting the successful introduction of trace Ru to the Ni/NiO@Ru—NC.²⁴ On the other hand, the corresponding deconvoluted peaks of C—N, C—O, and O—C═O in the C 1s profile of Ni/NiO@Ru—NC display positive shifts as compared to those of Ni/NiO@NC, illustrating that the introduced Ru sites affect the electron distribution in the NC matrix.

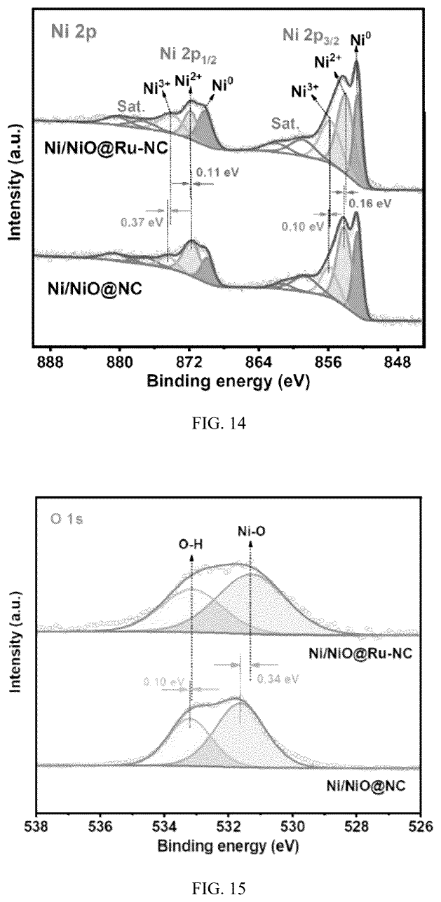

Meanwhile, the peak in the N 1s region of Ni/NiO@NC can be deconvoluted into three peaks at 398.71, 400.87, and 403.80 eV, which are ascribed to pyridinic-N, graphitic-N, and oxidized-N, respectively as shown in FIG. 13.²⁵ Similarly, all peaks shift toward higher binding energies after the Ru introduction. Notably, a new peak is observed at 399.82 eV in the N 1s region of Ni/NiO@Ru—NC, ascribed to the strong coordination of N atoms to Ru sites.²⁶ It is consistent with the observations in the reported research works regarding the single metal sites embedded in the NC matrix.^{11,27} Moreover, both high-resolution Ni 2p regions of the two samples demonstrate the coexistence of Ni and NiO as shown in FIG. 14, further confirming the generation of Janus Ni/NiO NPs coupled with the above TEM and Raman results. Specifically, for Ni/NiO@Ru—NC, two peaks at 852.60 and 870.16 eV are attributed to Ni⁰; two peaks at 853.99 and 871.82 eV are assigned to Ni²⁺; and two peaks at 855.71 and 874.03 eV are ascribed to Ni³⁺. Moreover, there are negative shifts for the Ni 2p and O 1s peaks of Ni/NiO@Ru—NC compared with those of Ni/NiO@NC as shown in FIG. 15, also demonstrating that electron redistribution occurs due to the introduction of Ru single atoms.

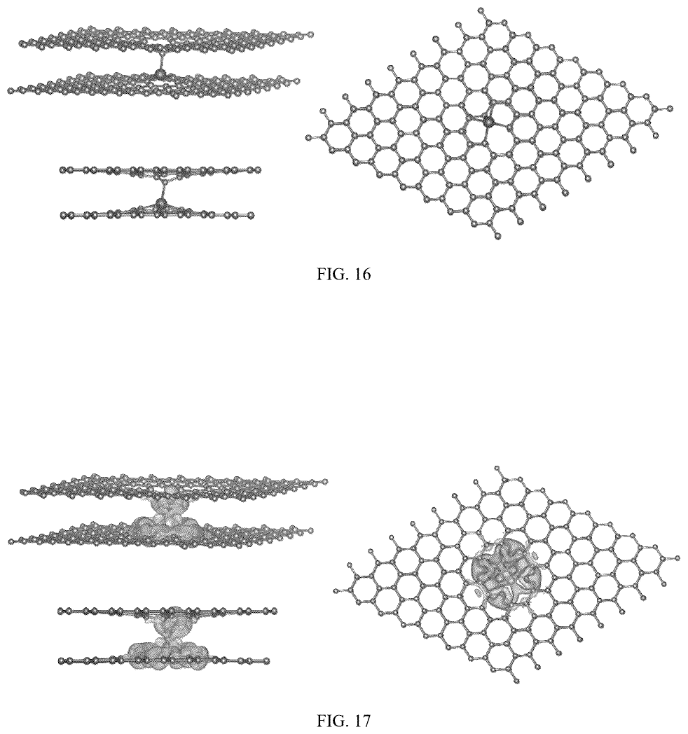

To further study the local structure and coordination environment of Ru atoms, X-ray absorption near-edge structure (XANES) and extended X-ray absorption fine structure (EXAFS) studies are conducted. FIG. 2E displays the XANES results at the Ru K-edge of the Ni/NiO@Ru—NC sample and the two references (i.e., Ru foil and RuO₂). The absorption edge position of Ni/NiO@Ru—NC is situated between that of Ru foil and RuO₂, manifesting that the Ru atom carries positive charges of +δ (0<δ<4).²⁸ More importantly, for Ni/NiO@Ru—NC, the Fourier-transformed (FT) k³-weighted EXAFS spectrum exhibits one prominent peak at about 1.5 Å, which is attributed to the Ru—N coordination shell. No Ru-Ru coordination peak is detected at approximately 2.4 or 3.1 Å as shown in FIG. 2F, jointly confirming the atomic-level dispersion of Ru atoms without the formation of metallic Ru or RuOₓ NPs in Ni/NiO@Ru—NC.²⁹ Furthermore, the EXAFS data-fitting results exhibit that the coordination number of Ru—N is 4.8, demonstrating that the dominant Ru—N structure of the Ni/NiO@Ru—NC catalyst could be Ru—N₅ as shown in FIG. 2G and Table 1. As a result, it can be assumed that the Ru—N₅ pyramid structure is composed of a Ru—N₄ planar structure with the axial coordination of pyridinic nitrogen,³⁰ which is illustrated in the inset of FIG. 2G and FIG. 16 after optimized by DFT calculations. In addition, the wavelet transform (WT) plot of Ni/NiO@Ru—NC displays one WT maximum at around 6 Å⁻¹ belonging to the Ru—N bonding as compared with Ru foil and RuO₂, which further indicates the isolated distribution of Ru atoms in Ni/NiO@Ru—NC (FIG. 2H).³¹

Furthermore, differential charge density analysis is conducted to illustrate the electron distribution within the Ni/NiO@Ru—NC nanotube. Based on the special spatial configuration of the nanotube, the Ru—N₅—C model is applied to study the sidewall part and the Ni/NiO@Ru—N₅—C model is used to analyze the top part, as shown in FIG. 2I. For the Ru—N₅—C configuration, an obvious electron redistribution occurs on the Ru atom and the adjacent N and C atoms due to the different electronegativity of atoms, as shown in FIG. 17.³² The quantitative estimation by Bader charges reveals that the metal Ru center donates electrons (1.217 e) to the adjacent N atoms, endowing the Ru center positive,³³ in agreement with the above XANES results. In this way, the electron-deficient Ru sites could serve as the active centers with regulated electron donor-acceptor properties for optimal adsorption of intermediates.³⁴ Besides, at the top part, for the Janus Ni/NiO NPs, a charge accumulation can be visualized at the interface between NiO and Ni, implying a built-in electric field generation at an intimately contacted heterointerface.³⁵ It can act as an expedited highway within the Janus Ni/NiO NPs for accelerating electron transport. Then, taking the hetero-structed Ni/NiO as a whole, when it contacts with Ru—N₅—C, a charge accumulation on the heterointerface occurs, demonstrating an accelerated charge transfer at the holistic top part by the construction of Janus NPs and their strong interaction with the Ru—N₅—C outer layer.

### EXAMPLE 2—Alkaline HER and OER Performance

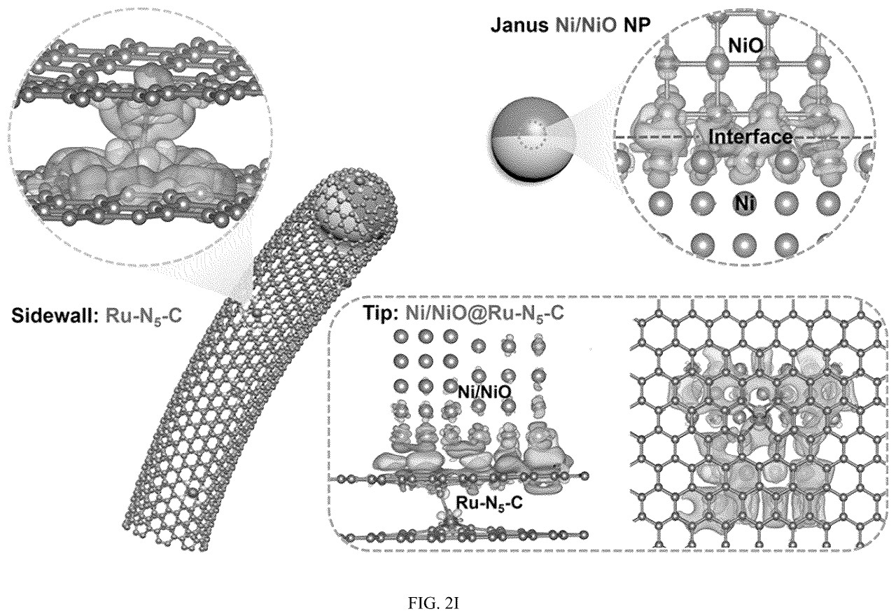

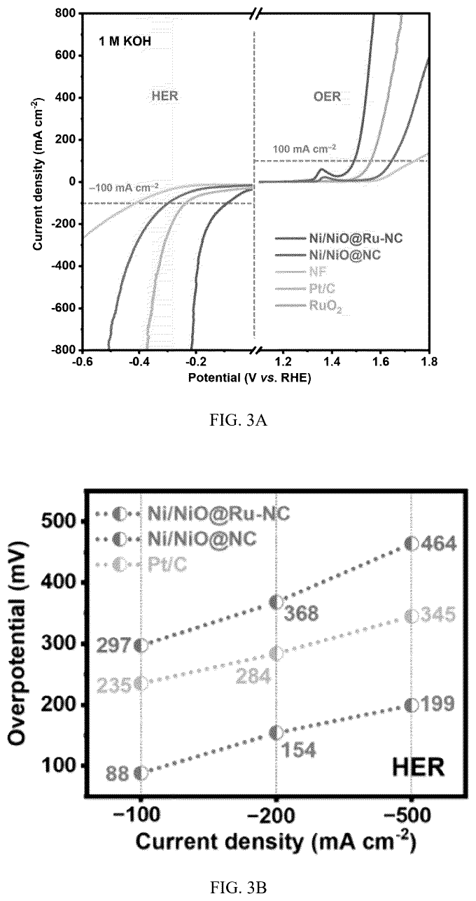

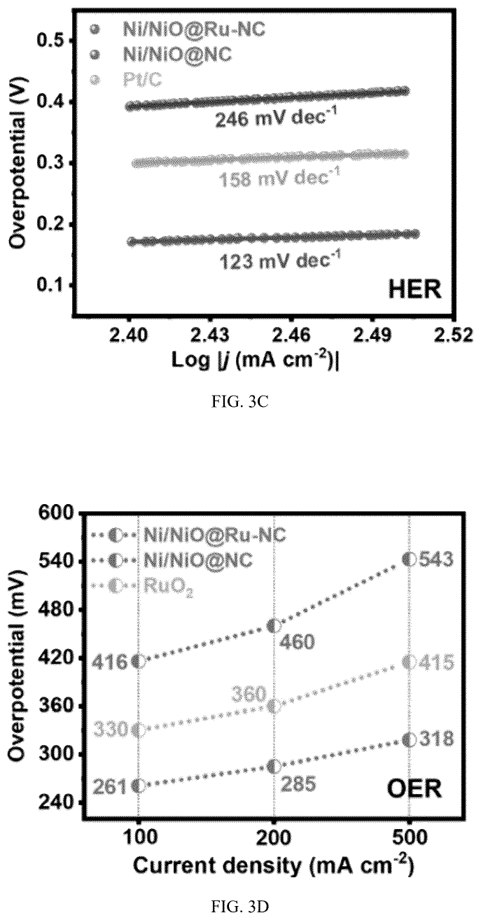

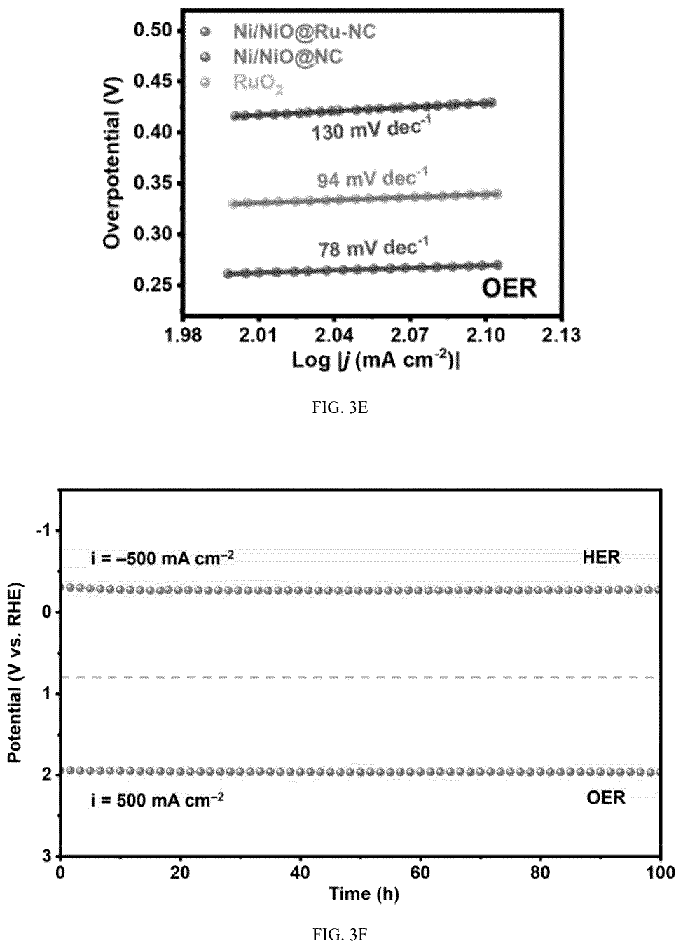

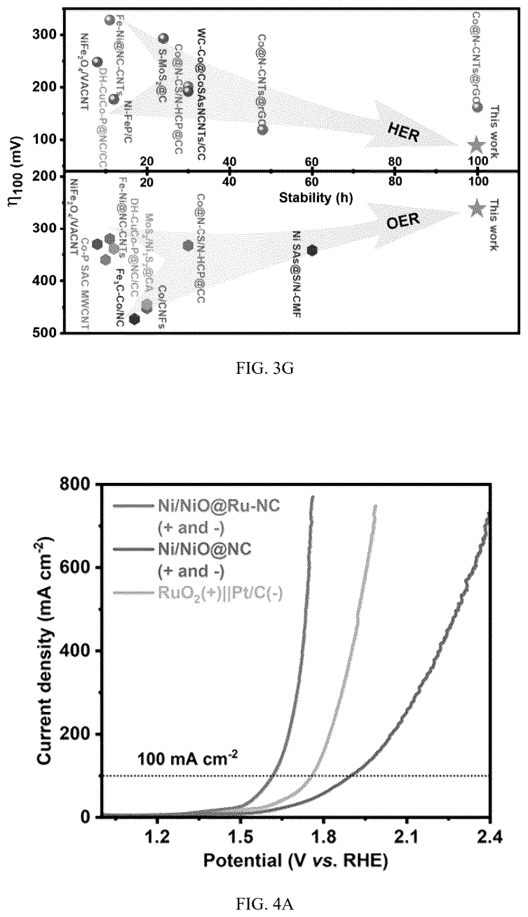

The HER activity of the Ni/NiO@Ru—NC, Ni/NiO@NC counterpart, benchmark Pt/C, and NF substrate is measured by a three-electrode system in a 1.0 M KOH solution. By tuning the Ru loading, the optimal Ni/NiO@Ru—NC sample for HER is used in subsequent tests, and the detailed results are displayed in FIGS. 18A-19. As shown in the polarization curves in FIG. 3A, when compared with Ni/NiO@NC (297, 368, and 464 mV) and Pt/C (235, 284, and 345 mV), Ni/NiO@Ru—NC exhibits the lowest overpotentials of 88, 154, and 199 mV in order to attain the current density of 100, 200, and 500 mA cm⁻², respectively as shown in FIG. 3B, displaying the best HER performance among the tested samples. Meanwhile, Ni/NiO@Ru—NC achieves the lowest Tafel slope of 123 mV dec⁻¹ in the composition of Pt/C (158 mV dec⁻¹) and Ni/NiO@NC (246 mV dec⁻¹) (FIG. 3C), suggesting that the synergistic effect of Ru single atoms and Janus Ni/NiO NPs within the NC nanotubes can provide more rapid kinetics.

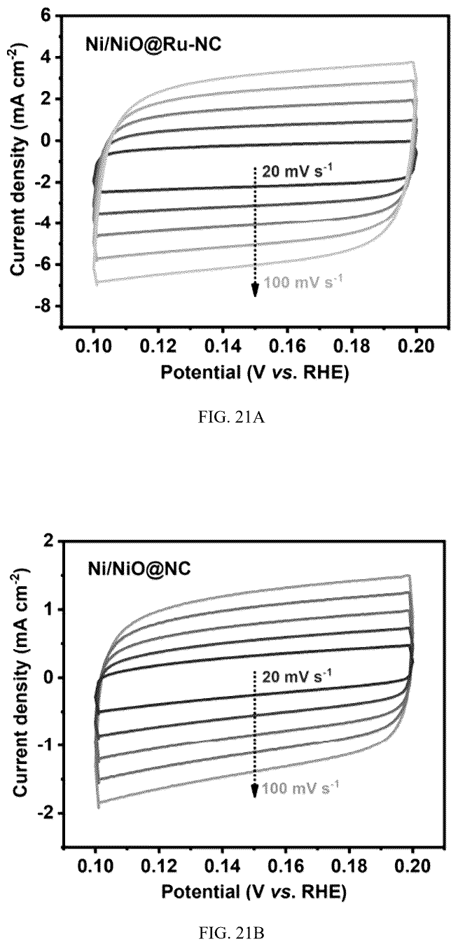

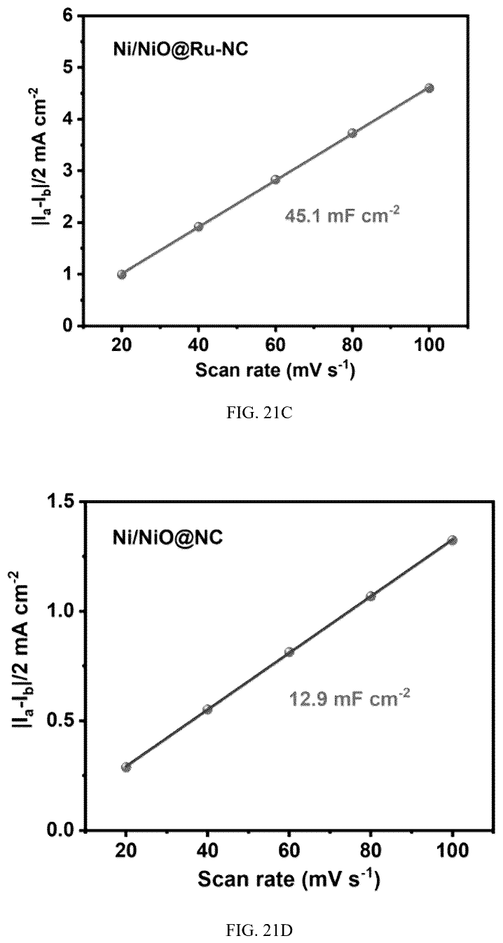

Moreover, the Nyquist plots in FIG. 20 and corresponding fitting results in Table 2 display that Ni/NiO@Ru—NC has a lower charge transfer resistance (1.405Ω) than that of Ni/NiO@NC (5.846Ω). In addition, the electrochemically active surface area (ECSA) is determined by double-layer capacitance (C_{dl}) with cyclic voltammetry (CV) measurements. The higher Cal value of Ni/NiO@Ru—NC (45.1 mF cm⁻²) than that of Ni/NiO@NC (12.9 mF cm⁻²) demonstrates there are much more catalytically active sites generated in Ni/NiO@Ru—NC for H₂ evolution as shown in FIGS. 21A-21D.³⁶ Therefore, these experimental results substantiate that the imported Ru single sites accompanied by the tip Ni/NiO NPs contribute to promoting the charge transfer and increasing the density of active sites for the whole array system, which is coincident with the calculated results from differential charge density.

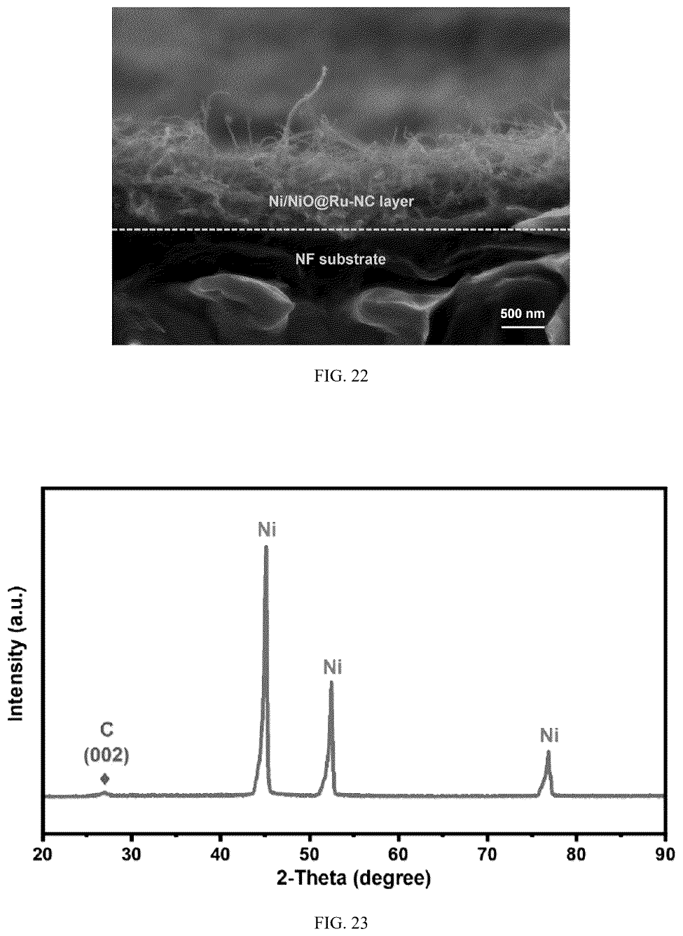

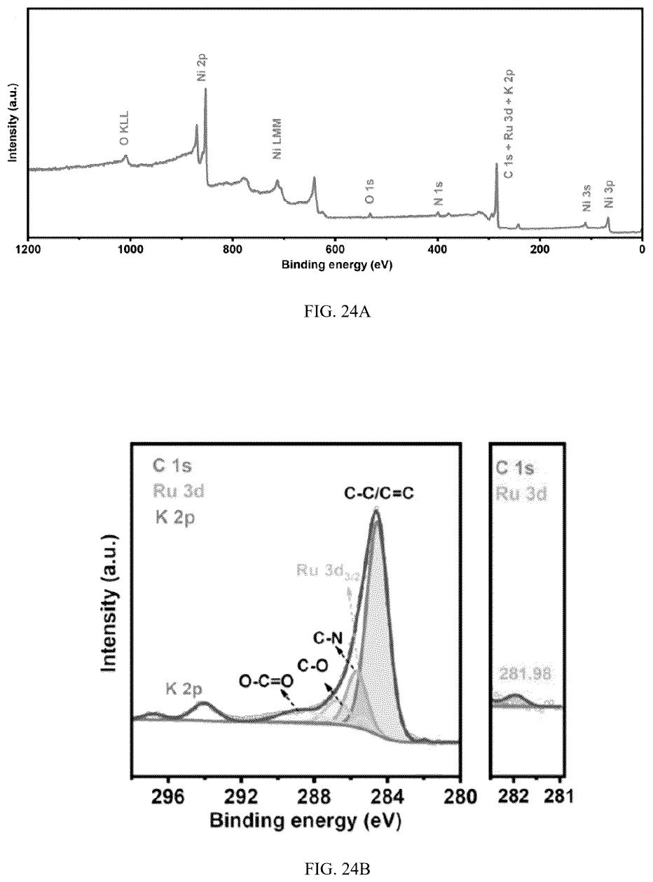

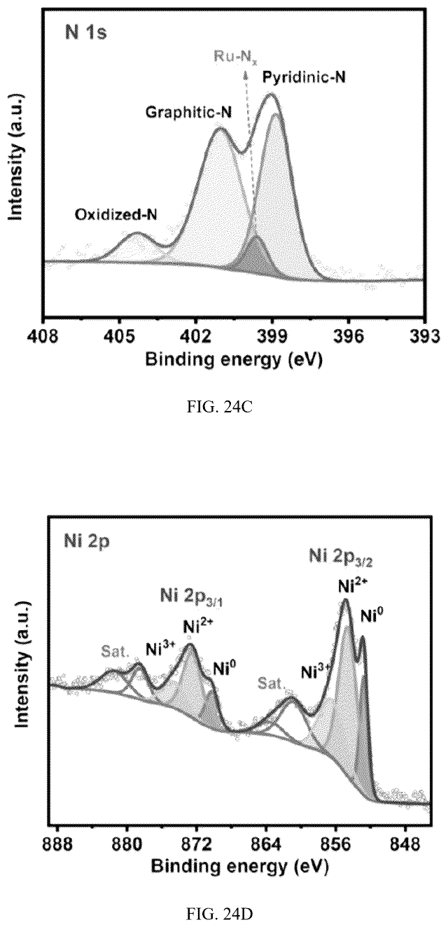

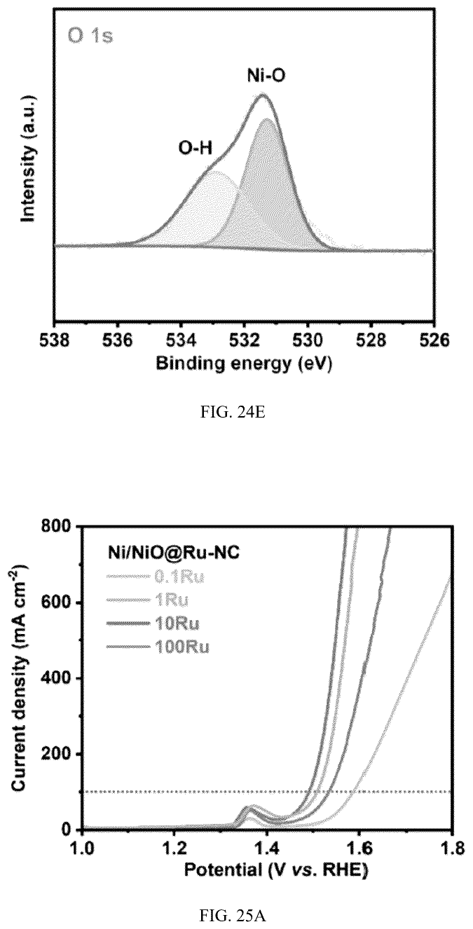

Afterward, a chronopotentiometry (CP) test is conducted to evaluate the durability of Ni/NiO@Ru—NC for the HER activity at −500 mA cm⁻². The potential is rather stable with negligible fluctuation in the strong reducing environment for 100 h, as shown in FIG. 3F, suggesting that the Ni/NiO@Ru—NC has good durability toward HER in an alkaline solution. On the other hand, the morphology of the long-term-tested sample observed from the SEM image is well-maintained in the nanotube structure with interconnected networks as open channels for the gas release so that it features good structural integrity, as shown in FIG. 22. The corresponding XRD result displays a pattern identical to the original Ni/NiO@Ru—NC sample (FIG. 23). Furthermore, the XPS results of Ni/NiO@Ru—NC subjected to the HER stability test reveal the coexistence of Ru, Ni (Ni³⁺/Ni²⁺/Ni⁰), O, N, and C elements, implying the elemental stability under the shielding with a robust carbon sheath as shown in FIGS. 24A-24E. Particularly, the alkaline HER activity and stability of Ni/NiO@Ru—NC surpass most reported carbon-based materials, ranking the top tier among the state-of-the-art carbon-supported metal-based electrocatalysts for alkaline HER reported to date, as shown in FIG. 3G and Table 3.

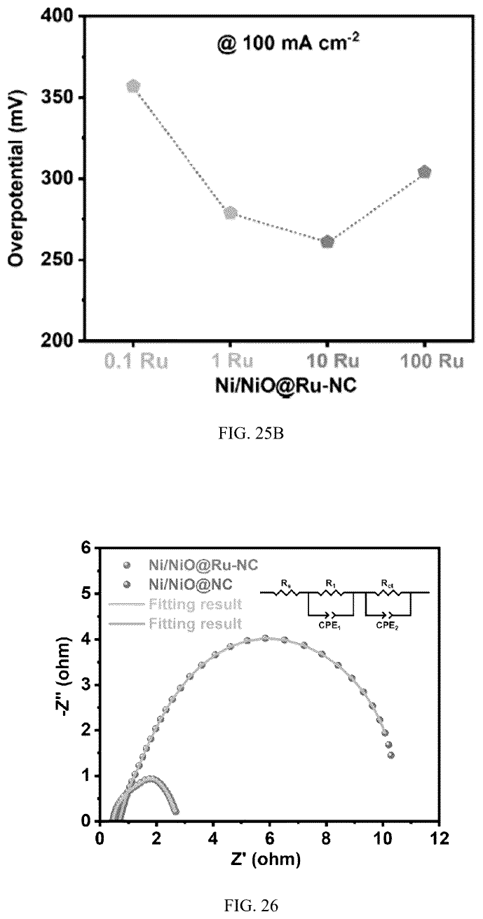

In the following, to investigate their OER performance, the Ni/NiO@Ru—NC, Ni/NiO@NC, NF substrate, and RuO₂ as the benchmark samples are tested via the three-electrode system in the 1.0MKOH solution. Similarly, the optimal Ni/NiO@Ru—NC sample for the OER is used in subsequent tests after tuning the Ru loading, and the detailed result is shown in FIGS. 25A and 25B. As depicted in FIG. 3A, the corresponding polarization curves demonstrate that Ni/NiO@Ru—NC features the best electrocatalytic OER activity among the tested electrocatalysts.

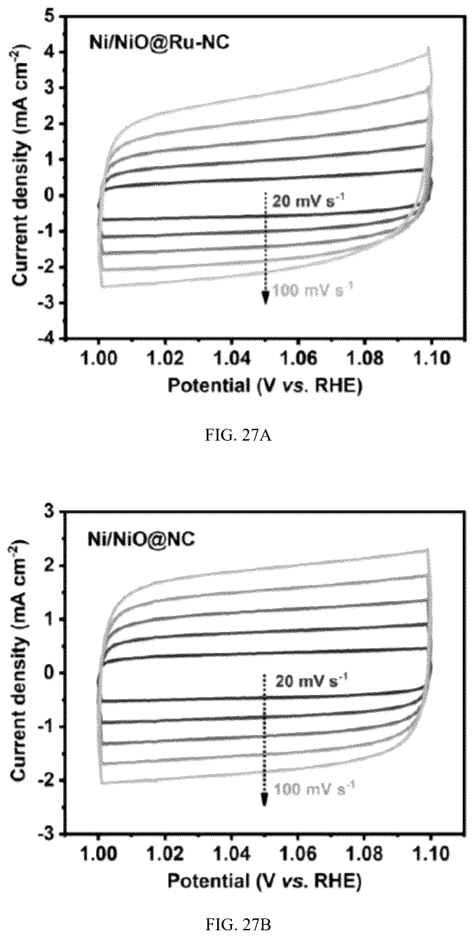

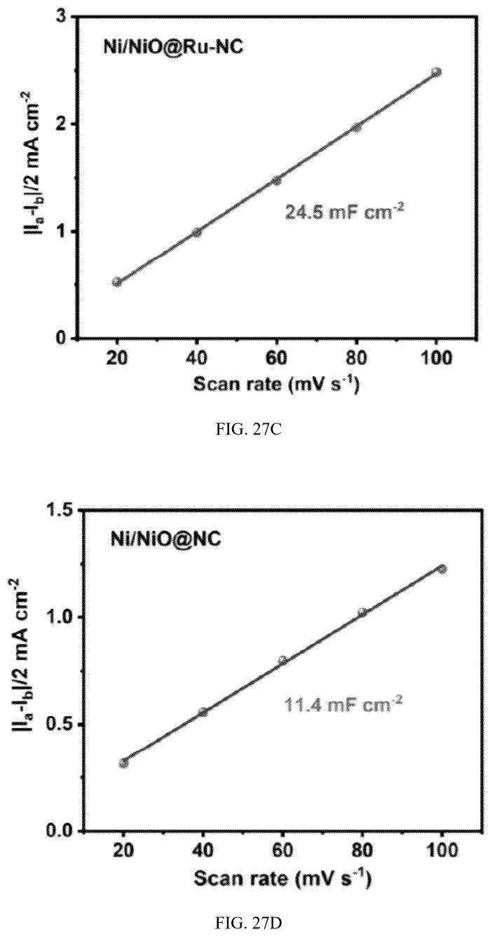

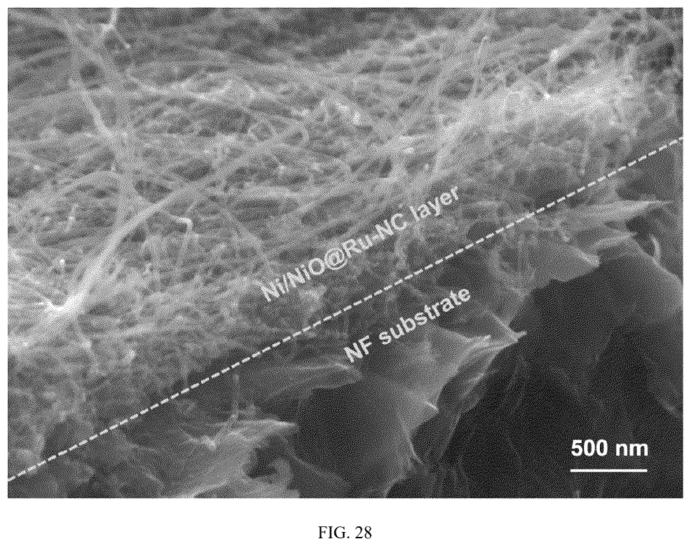

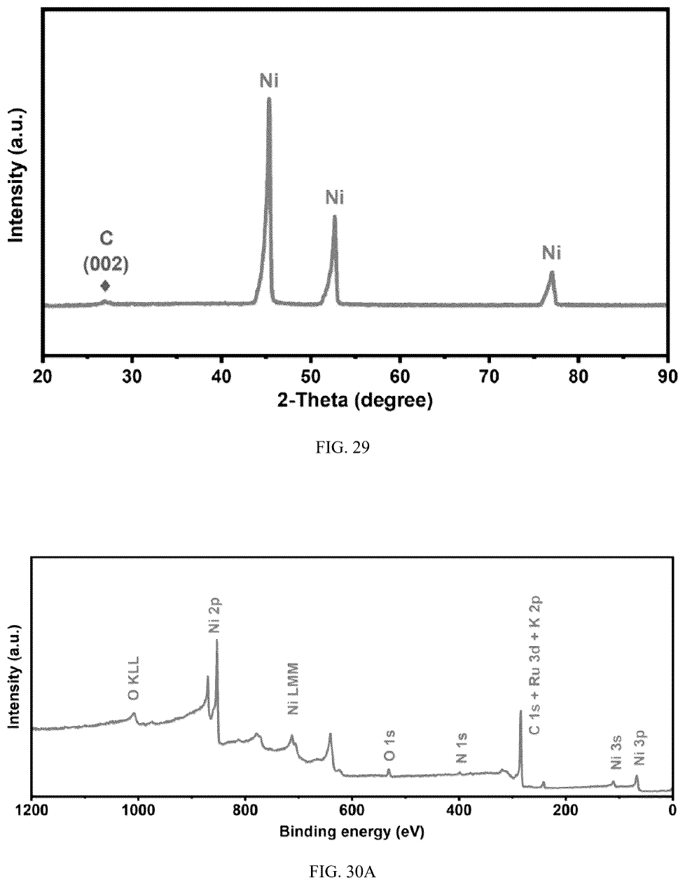

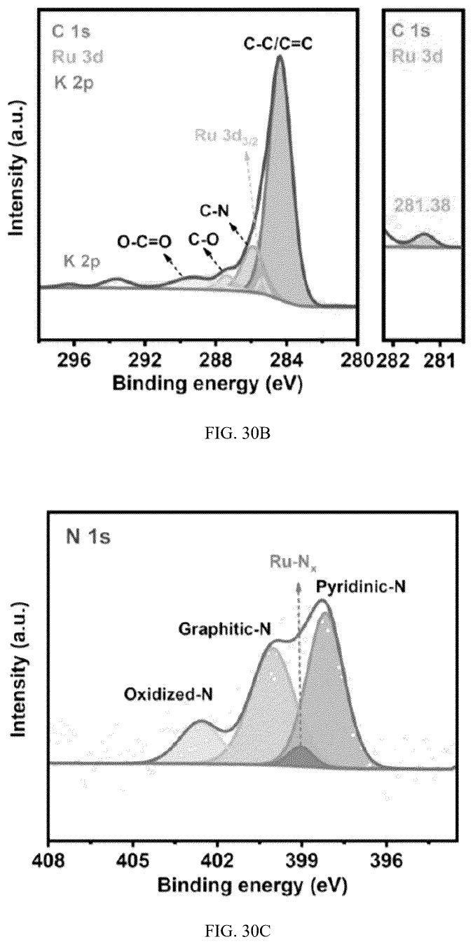

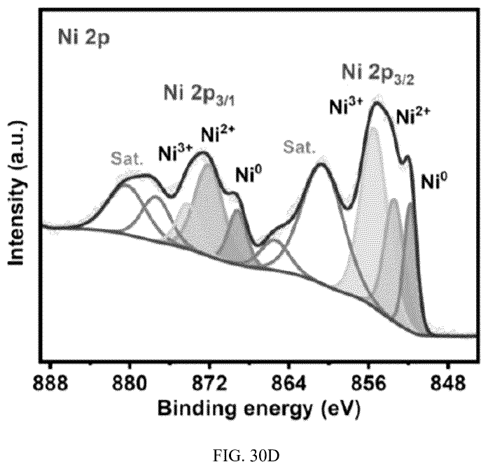

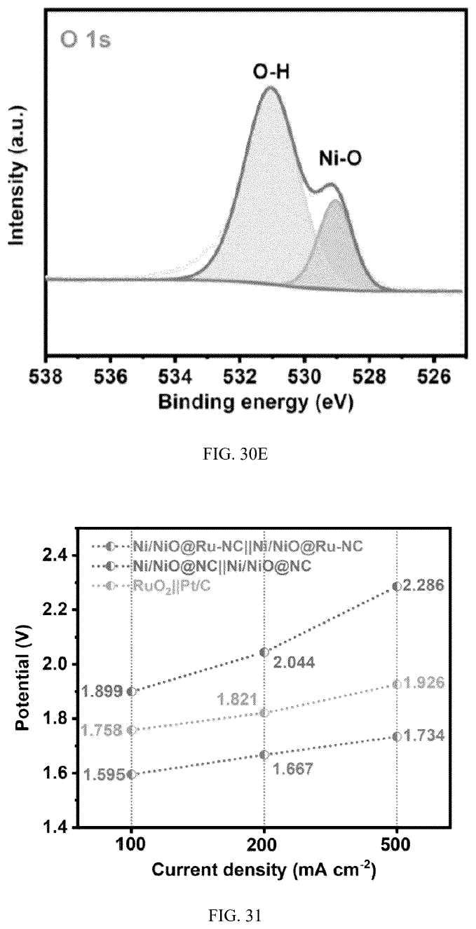

In the comparison of Ni/NiO@NC (416, 460, and 543 mV) and RuO₂ (330, 360, and 415 mV), Ni/NiO@Ru—NC requires low overpotentials of 261, 285, and 318 mV to achieve the current density of 100, 200, and 500 mA cm⁻², respectively as shown in FIG. 3D. Meanwhile, Ni/NiO@Ru—NC displays a smaller Tafel slope (78 mV dec⁻¹) than RuO₂ (94 mV dec⁻¹) and Ni/NiO@NC (130 mV dec⁻¹), as shown in FIG. 3E, demonstrating that the introduction of single-atom Ru and Janus Ni/NiO NPs also synergistically accelerates the OER kinetics.² Furthermore, as revealed by the Nyquist plots as shown in FIG. 26 and corresponding fitting results as shown in Table 4, the Ni/NiO@Ru—NC displays a lower charge transfer resistance (1.019Ω) than the Ni/NiO@NC (8.806Ω). The Ni/NiO@Ru—NC delivers a C_{dl} value of 24.5 mF cm⁻², which is larger than that of Ni/NiO@NC (11.4 mF cm⁻²), as shown in FIGS. 27A-27D. More importantly, Ni/NiO@Ru—NC exhibits good stability by sustaining 500 mA cm⁻² for 100 h with a negligible change of potential in 1.0 M KOH solution, as shown in FIG. 3F. The SEM image, XRD pattern, and XPS results for the Ni/NiO@Ru—NC subjected to the OER activity also reveal the well-maintained morphology and composition, further demonstrating the good durability of Ni/NiO@Ru—NC under the protection of a robust carbon matrix (FIGS. 28-30E). As a result, such good activity and stability of Ni/NiO@Ru—NC for alkaline OER are also among the best-reported values for carbon-supported metal-based OER electrocatalysts by far, as shown in FIG. 3G and Table 5.

### EXAMPLE 3—Overall Water Splitting Application and Mechanism Exploration

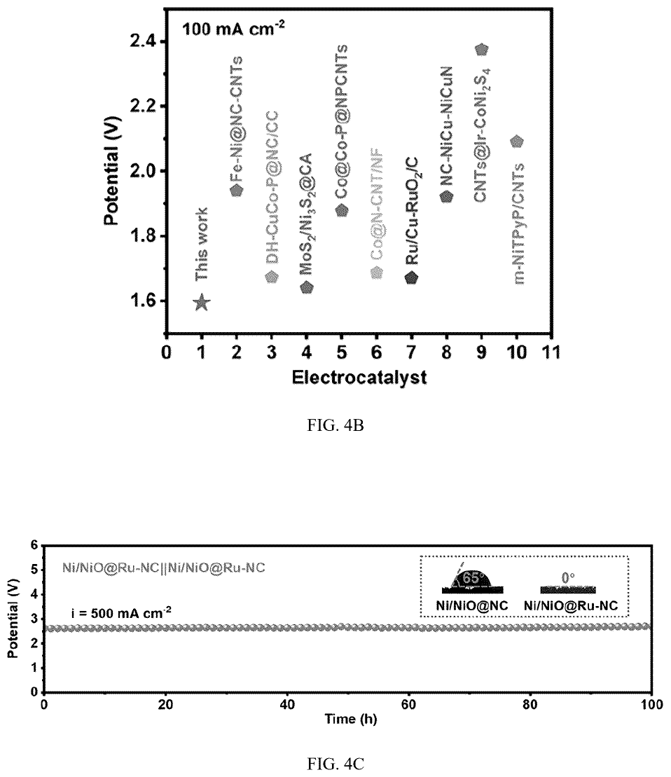

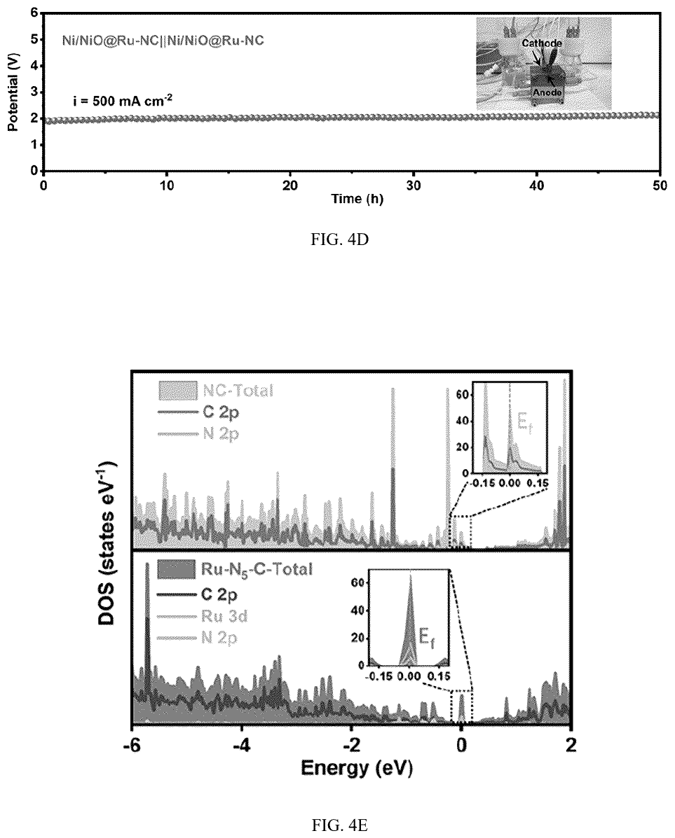

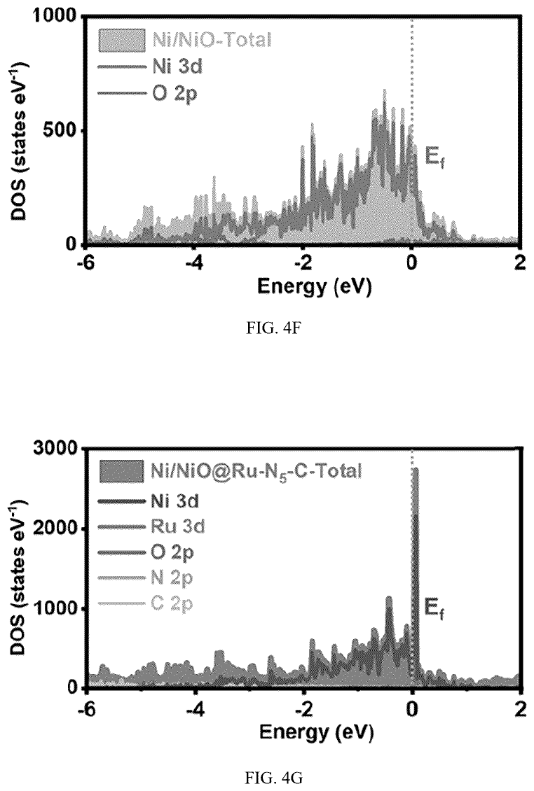

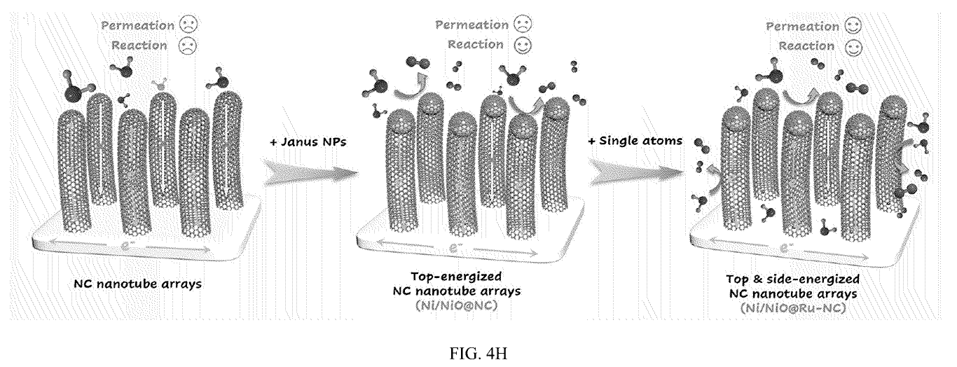

Encouraged by the good HER and OER performance, a two-electrode configuration electrolyzer for the overall water splitting application is integrated by the Ni/NiO@Ru—NC catalyst as both the anode and cathode in 1.0 M KOH solution. This electrolyzer is denoted as Ni/NiO@Ru—NC∥Ni/NiO@Ru—NC. In comparison, the Ni/NiO@NC∥Ni/NiO@NC and RuO₂∥Pt/C two-electrode configurations are also built and measured. As revealed in FIG. 4A, the Ni/NiO@Ru—NC∥Ni/NiO@Ru—NC can afford 100 mA cm⁻² only at the operating potential of 1.595 V, which is much superior to those of RuO₂∥Pt/C (1.758 V) and Ni/NiO@NC∥Ni/NiO@NC (1.899 V). Also, Ni/NiO@Ru—NC∥Ni/NiO@Ru—NC can reach 200 and 500 mA cm⁻² at 1.667 and 1.734 V, respectively as shown in FIG. 31. Notably, this performance is also superior to most reported carbon-based bifunctional electrocatalysts, as shown in FIG. 4B and Table 6. Moreover, the durability of this Ni/NiO@Ru—NC∥Ni/NiO@Ru—NC electrolyzer is evaluated at 500 mA cm⁻². The corresponding CP curve in FIG. 4C demonstrates that Ni/NiO@Ru—NC∥Ni/NiO@Ru—NC exhibits a steady cell voltage for 100 h, confirming the good robustness of Ni/NiO@Ru—NC for overall water splitting. Furthermore, encouraged by the good activity and stability of Ni/NiO@Ru—NC in the two-electrode configuration, it is integrated into an AEMWE system to reduce the ohmic loss during the electrocatalytic water-splitting process (inset, FIG. 4D). Similarly, in the compact AEMWE electrolyzer, the self-supported Ni/NiO@Ru—NC electrode, without using an ionomer, can act as an efficient and robust bifunctional catalyst with porous transport layers to operate stably for 50 h under 500 mA cm⁻² at a voltage of 1.95±0.05 V in 1.0 M KOH at room temperature, further indicating its good bifunctional performance and great potentials for practical applications as shown in FIG. 4D.

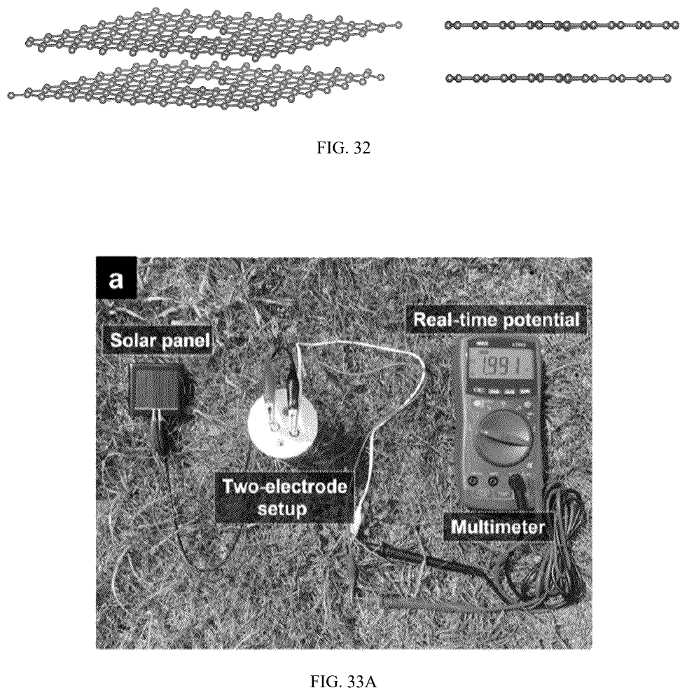

To disclose the underlying mechanism for the high electrocatalytic performance of the Ni/NiO@Ru—NC electrocatalyst, the total density of states (TDOS) and the partial density of states (PDOS) of NC, Ru—N₅—C, Ni/NiO, and Ni/NiO@Ru—N₅—C are calculated to study the intrinsic electronic structures. The NC model is applied as the optimized two-layer carbon with pyridinic nitrogen to compare with the Ru—N₅—C configuration, as shown in FIG. 32. As displayed in FIG. 4E, the confinement of Ru single atoms into NC generates higher electronic states near the Fermi level than that of NC because of the strongly coupled orbitals between the Ru 3d orbitals and the neighboring N 2p and C 2p orbitals, leading to a more conductive electronic structure.³⁷ Combining the results of differential charge density, the incorporation of Ru single atoms can regulate the electron distribution by strong d-p orbital couplings to activate the Ru—N₅—C domains with faster charge transfer, thus energizing the sidewalls of NC nanotubes for electrocatalytic reactions. On the other hand, in FIG. 4F, the Janus Ni/NiO has a band gap of zero as the substantial electronic states cross the Fermi energy (Ef). After the Ni/NiO is hybridized with Ru—N₅—C as shown in FIG. 4G, the Ni/NiO@Ru—N₅—C presents significantly higher PDOS states than that of Ni/NiO and Ru—N₅—C at the vicinity of the Fermi level, which demonstrates that the intimate heterointerface construction can regulate the orbital couplings with facilitated electron transfer, accelerating the reaction kinetics at the top part.³⁸ In this regard, stringing single Ru atoms and Janus Ni/NiO NPs can synergistically energize the NC nanotubes from sidewalls to tops with strong orbital couplings to facilitate charge transfer, prominently improving the reaction kinetics of the NC nanotube for electrocatalytic overall water splitting.

To better understand the advantages of multiscale confinement engineering in nanotube arrays, three cascaded models are proposed to illustrate the electrochemical process progressively, i.e., NC nanotube arrays, Ni/NiO@NC nanotube arrays, and Ni/NiO@Ru—NC nanotube arrays, respectively as shown in FIG. 4H. In principle, the surface of carbon is hydrophobic, inhibiting the permeation of OH⁻/H⁺, H₂O, and electrolytes. With an inferior mass diffusion, the electrolyte can only contact the apex of NC nanotube arrays. However, the NC lacks valid active sites to proceed with electrocatalytic HER and OER efficiently. In this regard, after introducing Janus Ni/NiO NPs within the apical domains of the NC nanotube, the top part of the Ni/NiO@NC nanotubes with the construction of heterointerfaces could provide more active sites and favorable charge transport at the reactant-accessible apex of the nanotube arrays, thus accelerating the

HER/OER processes as compared with those of pristine NC nanotube arrays. However, the electrolyte is still hard to permeate into the base of NC nanotube arrays, which limits the full play of whole NC nanotube arrays. In this case, when the Ru single atoms are imported into the NC matrix along with the apical Ni/NiO NPs, the NC nanotube arrays can be fully energized from top to sidewalls. Specifically, the formed Ru—NC can be more hydrophilic than the primitiveNCfor superior mass diffusion and can also significantly increase the density of active sites at the sidewalls. The promoted hydrophilic property of Ni/NiO@Ru—NC is proved by contact angle measurements. The water contact angle for Ni/NiO@NC is 65°. Meanwhile, when a droplet gets in touch with the surface of Ni/NiO@Ru—NC, it spreads quickly (i.e., the contact angle is close to) 0°, signifying a substantial enhancement in hydrophilicity after the introduction of single Ru atoms (inset, FIG. 4C). Therefore, the electrolyte can easily permeate into the base of Ni/NiO@Ru—NC nanotube arrays with good mass diffusion. The HER/OER processes can be further proceeded through the whole array system, not limited to the apical domains. Moreover, the flexible nanotube arrays forming different porosities can provide channels to rapidly release gaseous products, circumventing the structural destruction due to bubble accumulation at the base.

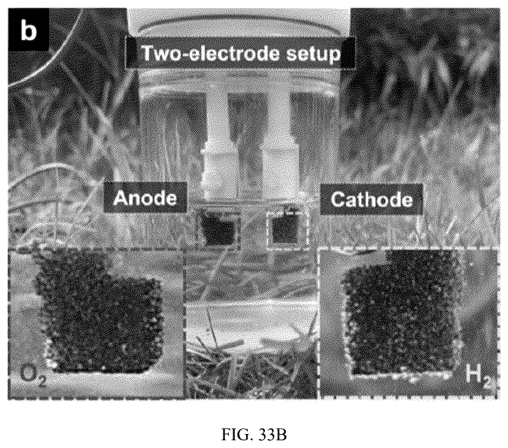

Taken together, the one-step LCVD method simultaneously confining Ru single atoms and Janus Ni/NiO NPs within NC nanotube arrays can be illustrated as one stone with three birds: (i) providing abundant active sites from top to sidewalls; (ii) regulating the electronic distribution to accelerate the electron transfer; (iii) increasing the hydrophilicity to facilitate the permeation of OH⁻/H⁺, H₂O, and electrolytes into the whole array system. Besides, the flexible nanotube arrays featuring porous channels can accelerate the generated gas bubble to detach from the active sites to reinforce their mechanical stability. Consequently, the Ni/NiO@Ru—NC nanotube arrays feature good activity and stability for overall water spitting. To further illustrate the feasibility of Ni/NiO@Ru—NC for practical applications, the solar-driven water-splitting electrolyzer is constructed by the Ni/NiO@Ru—NC∥Ni/NiO@ Ru—NC setup integrated with a silicon solar cell as shown in FIG. 33A. It is observed that enormous bubbles with a small size continuously generate and rapidly release from the two electrodes as shown in FIG. 33B, which demonstrates that the Ni/NiO@Ru—NC∥Ni/NiO@Ru—NC couple having a fast mass transfer can be efficiently driven by a commercial solar panel under sunlight irradiation. Therefore, it is indicated that Ni/NiO@Ru—NC can act as an efficient bifunctional electrocatalyst for potential industrial applications.

### CONCLUSION

In summary, the Ni/NiO@Ru—NC nanotube arrays are synthesized by multiscale confinement engineering using a simple one-step LCVD method, which simultaneously introduces single Ru atoms into the sidewalls and Janus Ni/NiO NPs at the apical domains to fully energize the NC nanotube arrays by regulating the electronic distribution. As a result, the Ni/NiO@Ru—NC exhibits good bifunctional HER and OER performance with long-term durability at high current densities, which can be ascribed to the accelerated charge transfer, improved mass diffusion, enriched active sites, and porous open channels derived from the flexible nanotube arrays. Specifically, the Ni/NiO@Ru—NC affords overpotentials of 88 and 199 mV at −100 and −500 mA cm⁻² for alkaline HER, respectively, and overpotentials of 261 and 318 mV at 100 and 500 mA cm⁻² for alkaline OER, respectively, both of which rank the top tier among reported carbon-supported metal-based materials. Moreover, Ni/NiO@Ru—NC drives the overall water-splitting to achieve 100 and 500 mA cm⁻² at cell voltages of 1.595 and 1.734 V, respectively. An overall water-splitting electrolyzer can be efficiently driven by a solar cell, and an AEMWE system can be stably operated under 500 mA cm⁻² for 50 h, demonstrating functional attributes useful for practical applications.

### EXEMPLARY EMBODIMENTS

Embodiment 1. A liquid-assisted chemical vapor deposition (LCVD) method for preparing hierarchical Ni/NiO@Ru—NC nanotube arrays, comprising:
pretreating nickel foam (NF); and
forming Ni/NiO@Ru—NC on surfaces of the NF with single-atom Ru anchored on a sidewall of N-doped carbon (Ru—NC) nanotubes and Janus Ni/NiO NPs encapsulated on tips of the nanotubes.

Embodiment 2. The method of embodiment 1, wherein the pretreating NF comprises:
immersing the NF into a H₂SO₄ solution with a predetermined concentration for a predetermined period of time;
cleansing the NF by sequential sonication treatments in acetone, ethanol, and deionized (DI) water; and
drying the NF at a predetermined temperature.

Embodiment 3. The method of embodiment 1, wherein the forming Ni/NiO@Ru—NC comprises:
placing the pretreated NF in a tube furnace;
connecting a gas washing bottle containing a CH₃CN solution and RuCl₃·xH₂O to an inlet of the tube furnace;
passing Argon (Ar) gas flow through the CH₃CN solution to create a CH₃CN/RuCl₃/Ar atmosphere in the tube furnace; and
calcinating the pretreated NF at a predetermined temperature for a predetermined period of time at a certain temperature ramping rate to form the Ni/NiO@Ru—NC.

Embodiment 4. The method of embodiment 3, wherein the predetermined temperature is about 700° C.

Embodiment 5. The method of embodiment 3, wherein the predetermined period of time is about 2 hours.

Embodiment 6. The method of embodiment 3, wherein the temperature ramping rate is about 5° C. min⁻¹.

Embodiment 7. The method of embodiment 3, wherein when the Ar gas flow is passed through the CH₃CN solution to create a CH₃CN/RuCl₃/Ar atmosphere in the tube furnace, the single-atom Ru anchored N-doped carbon (Ru—NC) nanotubes are in-situ grown on the pretreated NF with Janus Ni/NiO NPs encapsulated on the tips of the nanotubes by undertaking a carbothermal reduction process on the pretreated NF.

Embodiment 8. The method of embodiment 7, wherein during the carbothermal reduction process, the C₂H₃N is decomposed into species including hydrogen cyanide (HCN) and methane (CH₄), respectively acting as nitrogenous and carbonaceous feedstocks to form the Ru—NC nanotube.

Embodiment 9. The method of embodiment 7, wherein with a NiO layer formed on the surface of the pretreated NF, the Janus Ni/NiO NPs are first exsolved at a beginning of the process, and then the Ru—NC nanotubes start to grow with the Ni/NiO NPs at the tips, their length and density increasing with the growth time.

Embodiment 10. The method of embodiment 7, wherein each Janus Ni/NIO NP is encapsulated at a tip of the Ru—NC nanotube by the Ru—NC layers while a clear heterointerface exists between two phases within the NP.

Embodiment 11. A bifunctional Ni/NiO@Ru—NC electrocatalyst for water-splitting, the electrocatalyst comprising:
hierarchical Ni/NiO@Ru—NC nanotube arrays comprising single-atom Ru sites confined onto sidewalls and Janus Ni/NiO nanoparticles (NPs) confined at apical nanocavities of the nanotube arrays.

Embodiment 12. An electrolyzer for water splitting, comprising:
the bifunctional Ni/NiO@Ru—NC electrocatalyst of embodiment 11 as an anode and a cathode; and
an electrolyte solution; and
an anion-exchange membrane water electrolysis (AEMWE) system.

Embodiment 13. The electrolyzer of embodiment 12, the bifunctional Ni/NiO@Ru—NC electrocatalysts are configured to achieve at a steady voltage of 1.95±0.05 V in 1.0 M KOH at room temperature.

Embodiment 14. The electrolyzer of embodiment 12, wherein the electrolyte solution is a 1.0 M KOH solution.

Embodiment 15. The method of embodiment 2, wherein the predetermined concentration is about 0.5 M, the predetermined period of time is about 15 minutes, and the predetermined temperature is about 60° C.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application and the scope of the appended claims. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

### REFERENCES

(1) Cheng, F.; Peng, X.; Hu, L.; Yang, B.; Li, Z.; Dong, C. L.; Chen, J. L.; Hsu, L. C.; Lei, L.; Zheng, Q.; Qiu, M.; Dai, L.; Hou, Y. Accelerated Water Activation and Stabilized Metal-organic Framework via Constructing Triangular Active-regions for Ampere-level Current Density Hydrogen Production. Nat. Commun. 2022, 13, 6486.
(2) Li, P.; Wang, M.; Duan, X.; Zheng, L.; Cheng, X.; Zhang, Y.; Kuang, Y.; Li, Y.; Ma, Q.; Feng, Z.; Liu, W.; Sun, X. Boosting Oxygen Evolution of Single-atomic Ruthenium through Electronic Coupling with Cobalt-iron Layered Double Hydroxides. Nat. Commun. 2019, 10, 1711.
(3) Wang, Y.; Wang, S.; Ma, Z. L.; Yan, L. T.; Zhao, X. B.; Xue, Y. Y.; Huo, J. M.; Yuan, X.; Li, S. N.; Zhai, Q. G. Competitive Coordination-Oriented Monodispersed Ruthenium Sites in Conductive MOF/LDH Hetero-Nanotree Catalysts for Efficient Overall Water Splitting in Alkaline Media. Adv. Mater. 2022, 34, No. e2107488.
(4) Xu, H.; Shan, C.; Wu, X.; Sun, M.; Huang, B.; Tang, Y.; Yan, C.-H. Fabrication of Layered Double Hydroxide Microcapsules Mediated by Cerium Doping in Metal-organic Frameworks for Boosting Water Splitting. Energy Environ. Sci. 2020, 13, 2949-2956.
(5) Li, S.-H.; Qi, M.-Y.; Tang, Z.-R.; Xu, Y.-J. Nanostructured Metal Phosphides: from Controllable Synthesis to Sustainable Catalysis. Chem. Soc. Rev. 2021, 50, 7539-7586.
(6) Li, S.-H.; Zhang, N.; Xie, X.; Luque, R.; Xu, Y.-J. Stress-transferinduced In Situ Formation of Ultrathin Nickel Phosphide Nanosheets for Efficient Hydrogen Evolution. Angew. Chem., Int. Ed. 2018, 57, 13082-13085.
(7) Lei, C.; Wang, Y.; Hou, Y.; Liu, P.; Yang, J.; Zhang, T.; Zhuang, X.; Chen, M.; Yang, B.; Lei, L.; Yuan, C.; Qiu, M.; Feng, X. Efficient Alkaline Hydrogen Evolution on Atomically Dispersed Ni-Nx Species Anchored Porous Carbon with Embedded Ni Nanoparticles by Accelerating Water Dissociation Kinetics. Energy Environ. Sci. 2019, 12, 149-156.
(8) Xie, X.; He, C.; Li, B.; He, Y.; Cullen, D. A.; Wegener, E. C.; Kropf, A. J.; Martinez, U.; Cheng, Y.; Engelhard, M. H.; Bowden, M. E.; Song, M.; Lemmon, T.; Li, X. S.; Nie, Z.; Liu, J.; Myers, D. J.; Zelenay, P.; Wang, G.; Wu, G.; Ramani, V.; Shao, Y. Performance Enhancement and Degradation Mechanism Identification of A Single-atom Co—N—C Catalyst for Proton Exchange Membrane Fuel Cells. Nat. Catal. 2020, 3, 1044-1054.
(9) Zhao, D.; Sun, K.; Cheong, W. C.; Zheng, L.; Zhang, C.; Liu, S.; Cao, X.; Wu, K.; Pan, Y.; Zhuang, Z.; Hu, B.; Wang, D.; Peng, Q.; Chen, C.; Li, Y. Synergistically Interactive Pyridinic-N-MoP Sites: Identified Active Centers for Enhanced Hydrogen Evolution in Alkaline Solution. Angew. Chem., Int. Ed. 2020, 59, 8982-8990.
(10) Tong, Y.; Liu, J.; Wang, L.; Su, B. J.; Wu, K. H.; Juang, J. Y.; Hou, F.; Yin, L.; Dou, S. X.; Liu, J.; Liang, J. Carbon-Shielded Single-Atom Alloy Material Family for Multi-Functional Electrocatalysis. Adv. Funct. Mater. 2022, 32, 2205654.
(11) Li, Y.; Ji, Y.; Zhao, Y.; Chen, J.; Zheng, S.; Sang, X.; Yang, B.; Li, Z.; Lei, L.; Wen, Z.; Feng, X.; Hou, Y. Local Spin-state Tuning of Iron Single-atom Electrocatalyst by S-coordinated Doping for Kineticsboosted Ammonia Synthesis. Adv. Mater. 2022, 34, No. e2202240.
(12) Hou, Y.; Qiu, M.; Kim, M. G.; Liu, P.; Nam, G.; Zhang, T.; Zhuang, X.; Yang, B.; Cho, J.; Chen, M.; Yuan, C.; Lei, L.; Feng, X. Atomically Dispersed Nickel-nitrogen-sulfur Species Anchored on Porous Carbon Nanosheets for Efficient Water Oxidation. Nat. Commun. 2019, 10, 1392.
(13) Cui, X.; Gao, L.; Lei, S.; Liang, S.; Zhang, J.; Sewell, C. D.; Xue, W.; Liu, Q.; Lin, Z.; Yang, Y. Simultaneously Crafting Single-atomic Fe Sites and Graphitic Layer-wrapped Fe3C Nanoparticles Encapsulated within Mesoporous Carbon Tubes for Oxygen Reduction. Adv. Funct. Mater. 2021, 31, 2009197.
(14) Quan, Q.; Bu, X.; Chen, D.; Wang, F.; Kang, X.; Wang, W.; Meng, Y.; Yip, S.; Liu, C.; Ho, J. C. Sequential Self-reconstruction of Localized Mo Species in Hierarchical Carbon/Co—Mo Oxide Heterostructures for Boosting Alkaline Hydrogen Evolution Kinetics and Durability. J. Mater. Chem. A 2022, 10, 3953-3962.
(15) Lin, J.; Zeng, C.; Lin, X.; Xu, C.; Xu, X.; Luo, Y. Metal-organic Framework-derived Hierarchical MnO/Co with Oxygen Vacancies toward Elevated-Temperature Li-Ion Battery. ACS Nano 2021, 15, 4594-4607.
(16) Quan, Q.; Zhang, T.; Lei, C.; Yang, B.; Li, Z.; Chen, J.; Yuan, C.; Lei, L.; Hou, Y. Confined Carburization-Engineered Synthesis of Ultrathin Nickel Oxide/Nickel Heterostructured Nanosheets for Enhanced Oxygen Evolution Reaction. Nanoscale 2019, 11, 22261-22269.
(17) Tao, H.; Choi, C.; Ding, L.-X.; Jiang, Z.; Han, Z.; Jia, M.; Fan, Q.; Gao, Y.; Wang, H.; Robertson, A. W.; Hong, S.; Jung, Y.; Liu, S.; Sun, Z. Nitrogen Fixation by Ru Single-Atom Electrocatalytic Reduction. Chem. 2019, 5, 204-214.
(18) Aijaz, A.; Masa, J.; Rösler, C.; Xia, W.; Weide, P.; Botz, A. J. R.; Fischer, R. A.; Schuhmann, W.; Muhler, M. Co@Co3O4 Encapsulated in Carbon Nanotube-Grafted Nitrogen-Doped Carbon Polyhedra as an Advanced Bifunctional Oxygen Electrode. Angew. Chem., Int. Ed. 2016, 55, 4087-4091.
(19) Gong, W.; Lin, Y.; Chen, C.; Al-Mamun, M.; Lu, H.-S.; Wang, G.; Zhang, H.; Zhao, H. Nitrogen-doped Carbon Nanotube Confined Co—Nx Sites for Selective Hydrogenation of Biomass-derived Compounds. Adv. Mater. 2019, 31, 1808341.
(20) Cheng, Y.; Gong, J.; Cao, B.; Xu, X.; Jing, P.; Liu, B.; Gao, R.; Zhang, J. An Ingenious Strategy to Integrate Multiple Electrocatalytically Active Components within a Well-Aligned Nitrogen-Doped Carbon Nanotube Array Electrode for Electrocatalysis. ACS Catal. 2021, 11, 3958-3974.
(21) Ferrari, A. C.; Basko, D. M. Raman Spectroscopy as A Versatile Tool for Studying the Properties of Graphene. Nat. Nanotechnol. 2013, 8, 235-246.
(22) Chen, K.; Zhou, X.; Cheng, X.; Qiao, R.; Cheng, Y.; Liu, C.; Xie, Y.; Yu, W.; Yao, F.; Sun, Z.; Wang, F.; Liu, K.; Liu, Z. Graphene Photonic Crystal Fibre with Strong and Tunable Light-matter Interaction. Nat. Photonics 2019, 13, 754-759.
(23) Cui, X.; Gao, L.; Lei, S.; Liang, S.; Zhang, J.; Sewell, C. D.; Xue, W.; Liu, Q.; Lin, Z.; Yang, Y. Simultaneously Crafting Single-Atomic Fe Sites and Graphitic Layer-Wrapped Fe3C Nanoparticles Encapsulated within Mesoporous Carbon Tubes for Oxygen Reduction. Adv. Funct. Mater. 2021, 31, 2009197.
(24) Xiao, M.; Gao, L.; Wang, Y.; Wang, X.; Zhu, J.; Jin, Z.; Liu, C.; Chen, H.; Li, G.; Ge, J.; He, Q.; Wu, Z.; Chen, Z.; Xing, W. Engineering Energy Level of Metal Center: Ru Single-Atom Site for Efficient and Durable Oxygen Reduction Catalysis. J. Am. Chem. Soc. 2019, 141, 19800-19806.
(25) Ao, X.; Zhang, W.; Li, Z.; Li, J.-G.; Soule, L.; Huang, X.; Chiang, W.-H.; Chen, H. M.; Wang, C.; Liu, M.; Zeng, X. C. Markedly Enhanced Oxygen Reduction Activity of Single-Atom Fe Catalysts via Integration with Fe Nanoclusters. ACS Nano 2019, 13, 11853-11862.
(26) Chen, S.; Zhou, Y.; Li, J.; Hu, Z.; Dong, F.; Hu, Y.; Wang, H.; Wang, L.; Ostrikov, K. K.; Wu, Z. Single-atom Ru-implanted Metal-organic Framework/MnO2 for the Highly Selective Oxidation of NOx by Plasma Activation. ACS Catal. 2020, 10, 10185-10196.
(27) Wang, X.; Wang, Y.; Sang, X.; Zheng, W.; Zhang, S.; Shuai, L.; Yang, B.; Li, Z.; Chen, J.; Lei, L.; Adli, N. M.; Leung, M. K. H.; Qiu, M.; Wu, G.; Hou, Y. Dynamic Activation of Adsorbed Intermediates via Axial Traction for the Promoted Electrochemical CO2 Reduction. Angew. Chem., Int. Ed. 2021, 60, 4192-4198.
(28) Qin, Y.; Guo, C.; Ou, Z.; Xu, C.; Lan, Q.; Jin, R.; Liu, Y.; Niu, Y.; Xu, Q.; Si, Y.; Li, H. Regulating Single-atom Mn Sites by Precisely Axial Pyridinic-nitrogen Coordination to Stabilize the Oxygen Reduction. J. Energy Chem. 2023, 80, 542-552.
(29) Qi, H.; Yang, J.; Liu, F.; Zhang, L.; Yang, J.; Liu, X.; Li, L.; Su, Y.; Liu, Y.; Hao, R.; Wang, A.; Zhang, T. Highly Selective and Robust Single-atom Catalyst Rul/NC for Reductive Amination of Aldehydes/Ketones. Nat. Commun. 2021, 12, 3295.
(30) Zhang, H.; Li, J.; Xi, S.; Du, Y.; Hai, X.; Wang, J.; Xu, H.; Wu, G.; Zhang, J.; Lu, J.; Wang, J. A Graphene-Supported Single-Atom FeN5 Catalytic Site for Efficient Electrochemical CO2 Reduction. Angew. Chem., Int. Ed. 2019, 58, 14871-14876.
(31) Xue, D.; Yuan, P.; Jiang, S.; Wei, Y.; Zhou, Y.; Dong, C.-L.; Yan, W.; Mu, S.; Zhang, J.-N. Altering the Spin State of Fe—N—C Through Ligand Field Modulation of Single-atom Sites Boosts the Oxygen Reduction Reaction. Nano Energy 2023, 105, No. 108020.
(32) Kuang, P.; Wang, Y.; Zhu, B.; Xia, F.; Tung, C.-W.; Wu, J.; Chen, H. M.; Yu, J. Pt Single Atoms Supported on N-doped MesoporousHollow Carbon Spheres with Enhanced Electrocatalytic H2-Evolution Activity. Adv. Mater. 2021, 33, 2008599.
(33) Kumar, A.; Bui, V. Q.; Lee, J.; Wang, L.; Jadhav, A. R.; Liu, X.; Shao, X.; Liu, Y.; Yu, J.; Hwang, Y.; Bui, H. T. D.; Ajmal, S.; Kim, M. G.; Kim, S.-G.; Park, G.-S.; Kawazoe, Y.; Lee, H. Moving Beyond Bimetallic-alloy to Single-atom Dimer Atomic-interface for All-pH Hydrogen Evolution. Nat. Commun. 2021, 12, 6766.
(34) Zhu, J.; Guo, Y.; Liu, F.; Xu, H.; Gong, L.; Shi, W.; Chen, D.; Wang, P.; Yang, Y.; Zhang, C.; Wu, J.; Luo, J.; Mu, S. Regulative Electronic States around Ruthenium/Ruthenium Disulphide Heterointerfaces for Efficient Water Splitting in Acidic Media. Angew. Chem., Int. Ed. 2021, 60, 12328-12334.
(35) Liang, Q.; Zhong, L.; Du, C.; Luo, Y.; Zhao, J.; Zheng, Y.; Xu, J.; Ma, J.; Liu, C.; Li, S.; Yan, Q. Interfacing Epitaxial Dinickel Phosphide to 2D Nickel Thiophosphate Nanosheets for Boosting Electrocatalytic Water Splitting. ACS Nano 2019, 13, 7975-7984.
(36) Wang, Q.; Huang, X.; Zhao, Z. L.; Wang, M.; Xiang, B.; Li, J.; Feng, Z.; Xu, H.; Gu, M. Ultrahigh-Loading of Ir Single Atoms on NiO Matrix to Dramatically Enhance Oxygen Evolution Reaction. J. Am. Chem. Soc. 2020, 142, 7425-7433.
(37) Yu, H.; Xue, Y.; Huang, B.; Hui, L.; Zhang, C.; Fang, Y.; Liu, Y.; Zhao, Y.; Li, Y.; Liu, H.; Li, Y. Ultrathin Nanosheet of Graphdiyne-Supported Palladium Atom Catalyst for Efficient Hydrogen Production. iScience 2019, 11, 31-41.
(38) Zheng, X.; Cui, P.; Qian, Y.; Zhao, G.; Zheng, X.; Xu, X.; Cheng, Z.; Liu, Y.; Dou, S. X.; Sun, W. Multifunctional Active-Center-Transferable Platinum/Lithium Cobalt Oxide Heterostructured Electrocatalysts towards Superior Water Splitting. Angew. Chem., Int. Ed. 2020, 59, 14533-14540.
(39) Perdew, J. P.; Burke, K.; Ernzerhof, M. Generalized Gradient Approximation Made Simple. Phys. Rev. Lett. 1996, 77, 3865-3868. (40) Kresse, G.; Furthmüller, J. Efficient Iterative Schemes for Ab Initio Total-Energy Calculations Using a Plane-Wave Basis Set. Phys. Rev. B 1996, 54, 11169-11186.
(41) Blöchl, P. E. Projector Augmented-Wave Method. Phys. Rev. B 1994, 50, 17953-17979.
(42) Kresse, G.; Joubert, D. From Ultrasoft Pseudopotentials to the Projector Augmented-Wave Method. Phys. Rev. B 1999, 59, 1758-1775.
(43) Chen, Z.; Ha, Y.; Jia, H.; Yan, X.; Chen, M.; Liu, M.; Wu, R., Oriented Transformation of Co-LDH into 2D/3D ZIF-67 to Achieve Co—N—C Hybrids for Efficient Overall Water Splitting. Adv. Energy Mater. 2019, 9, 1803918.
(44) Zhao, X.; Pachfule, P.; Li, S.; Simke, J. R. J.; Schmidt, J.; Thomas, A., Bifunctional Electrocatalysts for Overall Water Splitting from an Iron/Nickel-Based Bimetallic Metal-Organic Framework/Dicyandiamide Composite. Angew. Chem. Int. Ed. 2018, 57, 8921-8926.
(45) Wang, X.; Huang, H.; Qian, J.; Li, Y.; Shen, K., Intensified Kirkendall Effect Assisted Construction of Double-shell Hollow Cu-doped CoP Nanoparticles Anchored by Carbon Arrays for Water Splitting. Appl. Catal., B 2023, 325, 122295.
(46) Xu, Y.; Yan, Y.; He, T.; Zhan, K.; Yang, J.; Zhao, B.; Qi, K.; Xia, B. Y., Supercritical CO2-assisted Synthesis of NiFe2O4/Vertically-aligned Carbon Nanotube Arrays Hybrid as A Bifunctional Electrocatalyst for Efficient Overall Water Splitting. Carbon 2019, 145, 201-208.
(47) Lu, X. F.; Yu, L.; Lou, X. W., Highly Crystalline Ni-doped FeP/Carbon Hollow Nanorods as All-pH Efficient and Durable Hydrogen Evolving Electrocatalysts. Sci. Adv. 5, eaav6009.
(48) Cheng, Y.; Gong, J.; Cao, B.; Xu, X.; Jing, P.; Liu, B.; Gao, R.; Zhang, J., An Ingenious Strategy to Integrate Multiple Electrocatalytically Active Components within a Well-Aligned Nitrogen-Doped Carbon Nanotube Array Electrode for Electrocatalysis. ACS Catal. 2021, 11, 3958-3974.
(49) Chen, Z.; Wu, R.; Liu, Y.; Ha, Y.; Guo, Y.; Sun, D.; Liu, M.; Fang, F., Ultrafine Co Nanoparticles Encapsulated in Carbon-Nanotubes-Grafted Graphene Sheets as Advanced Electrocatalysts for the Hydrogen Evolution Reaction. Adv. Mater. 2018, 30, e1802011.
(50) Gong, Y.; Wang, L.; Xiong, H.; Shao, M.; Xu, L.; Xie, A.; Zhuang, S.; Tang, Y.; Yang, X.; Chen, Y.; Wan, P., 3D Self-supported Ni Nanoparticle@N-doped Carbon Nanotubes Anchored on NiMoN Pillars for the Hydrogen Evolution Reaction with High Activity and Anti-oxidation Ability. J. Mater. Chem. A 2019, 7, 13671-13678.
(51) Xu, Q.; Liu, Y.; Jiang, H.; Hu, Y.; Liu, H.; Li, C., Unsaturated Sulfur Edge Engineering of Strongly Coupled MoS2 Nanosheet-Carbon Macroporous Hybrid Catalyst for Enhanced Hydrogen Generation. Adv. Energy Mater. 2019, 9, 1802553.
(52) Yang, Z.; Zhao, C.; Qu, Y.; Zhou, H.; Zhou, F.; Wang, J.; Wu, Y.; Li, Y., Trifunctional Self-Supporting Cobalt-Embedded Carbon Nanotube Films for ORR, OER, and HER Triggered by Solid Diffusion from Bulk Metal. Adv. Mater. 2019, 31, 1808043.
(53) Zhang, B.; Luo, H.; Ai, B.; Gou, Q.; Deng, J.; Wang, J.; Zheng, Y.; Xiao, J.; Li, M., Modulating Surface Electron Density of Heterointerface with Bio-inspired Light-Trapping Nano-Structure to Boost Kinetics of Overall Water Splitting. Small 2023, 19, 2205431.
(54) Yang, C. C.; Zai, S. F.; Zhou, Y. T.; Du, L.; Jiang, Q., Fe3C—Co Nanoparticles Encapsulated in A Hierarchical Structure of N-Doped Carbon as A Multifunctional Electrocatalyst for ORR, OER, and HER. Adv. Funct. Mater. 2019, 29, 1901949.
(55) Kang, S.; Jeong, Y. K.; Mhin, S.; Ryu, J. H.; Ali, G.; Lee, K.; Akbar, M.; Chung, K. Y.; Han, H.; Kim, K. M., Pulsed Laser Confinement of Single Atomic Catalysts on Carbon Nanotube Matrix for Enhanced Oxygen Evolution Reaction. ACS Nano 2021, 15, 4416-4428.
(56) Zhao, Y.; Guo, Y.; Lu, X. F.; Luan, D.; Gu, X.; Lou, X. W., Exposing Single Ni Atoms in Hollow S/N-Doped Carbon Macroporous Fibers for Highly Efficient Electrochemical Oxygen Evolution. Adv. Mater. 2022, 34, 2203442.
(57) Jiao, J.; Yang, W.; Pan, Y.; Zhang, C.; Liu, S.; Chen, C.; Wang, D., Interface Engineering of Partially Phosphidated Co@Co—P@NPCNTs for Highly Enhanced Electrochemical Overall Water Splitting. Small 2020, 16, 2002124.
(58) Yang, L.; Li, H.; Yu, Y.; Wu, Y.; Zhang, L., Assembled 3D MOF on 2D Nanosheets for Self-boosting Catalytic Synthesis of N-doped Carbon Nanotube Encapsulated Metallic Co Electrocatalysts for Overall Water Splitting. Appl. Catal., B 2020, 271, 118939.
(59) Yang, K.; Xu, P.; Lin, Z.; Yang, Y.; Jiang, P.; Wang, C.; Liu, S.; Gong, S.; Hu, L.; Chen, Q., Ultrasmall Ru/Cu-doped RuO2 Complex Embedded in Amorphous Carbon Skeleton as Highly Active Bifunctional Electrocatalysts for Overall Water Splitting. Small 2018, 14, 1803009.
(60) Hou, J.; Sun, Y.; Li, Z.; Zhang, B.; Cao, S.; Wu, Y.; Gao, Z.; Sun, L., Electrical Behavior and Electron Transfer Modulation of Nickel-copper Nanoalloys Confined in Nickel-Copper Nitrides Nanowires Array Encapsulated in Nitrogen-doped Carbon Framework as Robust Bifunctional Electrocatalyst for Overall Water Splitting. Adv. Funct. Mater. 2018, 28, 1803278.
(61) Zhu, X.; Nguyen, D. C.; Prabhakaran, S.; Kim, D. H.; Kim, N. H.; Lee, J. H., Activating Catalytic Behavior of Binary Transition Metal Sulfide-shelled Carbon Nanotubes by Iridium Incorporation toward Efficient Overall Water Splitting. Mater. Today Nano 2023, 21, 100296.
(62) Zhang, Y.; Chen, S.; Zhang, Y.; Li, R.; Zhao, B.; Peng, T., Hydrogen-Bond Regulation of Microenvironment of Ni (II)-Porphyrin Bifunctional Electrocatalysts for Efficient Overall Water Splitting. Adv. Mater. 2023, 2210727.

We claim:

1. A liquid-assisted chemical vapor deposition (LCVD) method for preparing hierarchical Ni/NiO@Ru—NC nanotube arrays, comprising:
pretreating nickel foam (NF); and
forming Ni/NiO@Ru—NC on surfaces of the NF with single-atom Ru anchored on a sidewall of N-doped carbon (Ru—NC) nanotubes and Janus Ni/NiO NPs encapsulated on tips of the nanotubes.

2. The method of claim 1, wherein the pretreating NF comprises:
immersing the NF into a H₂SO₄ solution with a predetermined concentration for a predetermined period of time;
cleansing the NF by sequential sonication treatments in acetone, ethanol, and deionized (DI) water; and
drying the NF at a predetermined temperature.

3. The method of claim 1, wherein the forming Ni/NiO@Ru—NC comprises:
placing the pretreated NF in a tube furnace;
connecting a gas washing bottle containing a CH₃CN solution and RuCl₃·xH₂O to an inlet of the tube furnace;
passing Argon (Ar) gas flow through the CH₃CN solution to create a CH₃CN/RuCl₃/Ar atmosphere in the tube furnace; and
calcinating the pretreated NF at a predetermined temperature for a predetermined period of time at a certain temperature ramping rate to form the Ni/NiO@Ru—NC.

4. The method of claim 3, wherein the predetermined temperature is about 700° C.

5. The method of claim 3, wherein the predetermined period of time is about 2 hours.

6. The method of claim 3, wherein the temperature ramping rate is about 5° C. min⁻¹.

7. The method of claim 3, wherein when the Ar gas flow is passed through the CH₃CN solution to create a CH₃CN/RuCl₃/Ar atmosphere in the tube furnace, the single-atom Ru anchored N-doped carbon (Ru—NC) nanotubes are in-situ grown on the pretreated NF with Janus Ni/NiO NPs encapsulated on the tips of the nanotubes by undertaking a carbothermal reduction process on the pretreated NF.

8. The method of claim 7, wherein during the carbothermal reduction process, the C₂H₃N is decomposed into species including hydrogen cyanide (HCN) and methane (CH₄), respectively acting as nitrogenous and carbonaceous feedstocks to form the Ru—NC nanotube.

9. The method of claim 7, wherein with a NiO layer formed on the surface of the pretreated NF, the Janus Ni/NiO NPs are first exsolved at a beginning of the process, and then the Ru—NC nanotubes start to grow with the Ni/NiO NPs at the tips, their length and density increasing with the growth time.

10. The method of claim 7, wherein each Janus Ni/NiO NP is encapsulated at a tip of the Ru—NC nanotube by the Ru—NC layers while a clear heterointerface exists between two phases within the NP.

11. A bifunctional Ni/NiO@Ru—NC electrocatalyst for water-splitting, the electrocatalyst comprising:
hierarchical Ni/NiO@Ru—NC nanotube arrays comprising single-atom Ru sites confined onto sidewalls and Janus Ni/NiO nanoparticles (NPs) confined at apical nanocavities of the nanotube arrays.

12. An electrolyzer for water splitting, comprising:
the bifunctional Ni/NiO@Ru—NC electrocatalyst of claim 11 as an anode and a cathode; and
an electrolyte solution; and
an anion-exchange membrane water electrolysis (AEMWE) system.

13. The electrolyzer of claim 12, the bifunctional Ni/NiO@Ru—NC electrocatalysts are configured to achieve at a steady voltage of 1.95±0.05 Vin 1.0 M KOH at room temperature.

14. The electrolyzer of claim 12, wherein the electrolyte solution is a 1.0 M KOH solution.

15. The method of claim 2, wherein the predetermined concentration is about 0.5 M, the predetermined period of time is about 15 minutes, and the predetermined temperature is about 60° C.
